(19) United States
(12) Patent Application Publication
(10) Pub. No.: US 2022/0339677 A1
(43) Pub. Date: Oct. 27, 2022

(54) PIPELINE CLEANOUT TOOL

(71) Applicant: HURRICANE REINSTATEMENT SOLUTIONS, LLC, Tucson, AZ (US)

(72) Inventor: MICHAEL GESTY, Tucson, AZ (US)

(73) Assignee: HURRICANE REINSTATEMENT SOLUTIONS, LLC, Tucson, AZ (US)

(21) Appl. No.: 17/763,976

(22) PCT Filed: Sep. 25, 2020
(86) PCT No.: PCT/US20/52876

§ 371 Date: Mar. 25, 2022

Related U.S. Application Data
(60) Provisional application No. 62/906,051, filed on Sep. 25, 2019.
(60) Provisional application No. 62/916,685, filed on Oct. 17, 2019.

(51) Int. Cl. B08B 9/045; B08B 9/057

(52) U.S. Cl. CPC B08B 9/045; B08B 9/057

(57) ABSTRACT

A new, innovative pipeline cleanout tool useful in removing debris and accretions from pipelines prior to reinstating the pipeline. The pipeline cleanout tool includes rotatable cleaning head assembly that includes a cylindrical body having a first end surface and a second end surface. A plurality of grooves formed in the first end surface and a plurality of grooves formed in the second end surface accept the insertion of arcuate flexible metal elements that extend spirally outward from the surface of the cylindrical member. The arcuate flexible metal elements, when compressed form an arcuate flexible metal element ring that contacts the interior surface of the pipeline. The rotatable cleaning head assembly also includes a first end cap and a second end cap, both end caps physically coupled to the cylindrical body and a rotatable flexible shaft. The tool further includes spacer elements and compressible elements disposed about the rotatable flexible shaft.

### CROSS REFERENCE TO RELATED APPLICATIONS

This application is a US National Stage Application of PCT Application PCT/US20/52876 filed Sep. 25, 2020, and claims benefit of U.S. Provisional Application 62/916,685 filed Oct. 17, 2019, and U.S. Provisional Application 62/906,051 filed Sep. 25, 2019.

### TECHNICAL FIELD

The present disclosure relates to tools useful for cleaning accretions from an in-situ pipeline, more specifically, for cleaning such accretions prior to in-situ reinstatement of the pipeline.

### BACKGROUND

As pipelines age and deteriorate, few options exist other than replacement, which can be disruptive, financially costly, and time consuming. An alternative is in-situ replacement or restoration of the pipeline using a formed in-place liner that takes advantage of the remaining structure provided by the pipeline. Prior to insertion of the liner material, a cleaning operation in which built-up material within the pipeline is removed and the pipeline is restored, to the greatest extent possible, to the original bore. After cleaning the pipeline, a flexible fabric or fiberglass tube may be impregnated with a chemically, thermally, or electromagnetically curable resin. The flexible tube is routed through the deteriorated pipeline and expanded to provide a full-bore or near full-bore passage. The resin is then cured, providing a seamless, rigid, lining system that extends the length of the pipeline.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1A is an elevation view of an illustrative pipeline cleanout tool that includes a rotatable cleaning head assembly physically coupled to a first end of a flexible rotating shaft, at least one stabilizer element slideably disposed about the flexible rotating shaft, and at least one compressible element disposed about the flexible rotating shaft, at least one flexible sleeve disposed about the flexible rotatable shaft, and a coupling element disposed about the flexible rotatable shaft and proximate the second end of the flexible rotatable shaft, in accordance with at least one embodiment described herein;

FIG. 1B is an elevation view along sectional line 1B-1B of the illustrative rotatable cleaning head assembly that more clearly depicts an illustrative plurality of arcuate flexible metal elements, arranged in one or more rows along the longitudinal axis of the flexible rotating shaft and extending outward from the body of the rotatable cleaning head assembly, in accordance with at least one embodiment described herein;

FIG. 1C is a cross-sectional elevation of the illustrative rotatable cleaning head assembly along sectional line 1C-1C as depicted in FIG. 1B, in accordance with at least one embodiment described herein;

FIG. 1D is a cross-sectional elevation along sectional line 1D-1D that depicts the at least one compressible element disposed about the flexible rotating shaft, in accordance with at least one embodiment described herein;

FIG. 1E is a cross-sectional elevation along sectional line 1E-1E that depicts the at least one stabilizer element disposed about the flexible rotating shaft, in accordance with at least one embodiment described herein;

FIG. 1F is a cross-sectional elevation along sectional line 1F-1F that depicts the at least one flexible sleeve disposed about the flexible rotating shaft, in accordance with at least one embodiment described herein;

FIG. 2A is a perspective view of an illustrative pipeline cleanout tool that includes a rotatable cleaning head assembly physically coupled to the first end of a flexible rotatable shaft, a spacer element disposed at an intermediate location along the flexible rotatable shaft, and a coupling element disposed proximate the second end of the flexible rotatable shaft, in accordance with at least one embodiment described herein;

FIG. 2B is a close-up perspective view of the rotatable cleaning head assembly included in the illustrative pipeline cleanout tool depicted in FIG. 2A, in accordance with at least one embodiment described herein;

FIG. 2C is another close-up perspective view of the rotatable cleaning head assembly included in the illustrative pipeline cleanout tool depicted in FIG. 2A, in accordance with at least one embodiment described herein;

FIG. 2D is a reverse close-up perspective view of the rotatable cleaning head assembly included in the illustrative pipeline cleanout tool depicted in FIG. 2A, in accordance with at least one embodiment described herein;

FIG. 3A is a perspective view of an illustrative arcuate flexible metal element, in accordance with at least one embodiment described herein;

FIG. 3B is another perspective view of the illustrative arcuate flexible metal element depicted in FIG. 3A, in accordance with at least one embodiment described herein;

FIG. 3C is yet another perspective view of the illustrative arcuate flexible metal element depicted in FIGS. 3A and 3B, in accordance with at least one embodiment described herein;

FIG. 4A is a perspective view of an illustrative cylindrical body that includes a plurality of grooves to accept the slideable insertion of at least one arcuate flexible metal element, in accordance with at least one embodiment described herein;

FIG. 4B is a plan view of the illustrative cylindrical body depicted in FIG. 4A, in accordance with at least one embodiment described herein;

FIG. 4C is a perspective view of an illustrative cylindrical body with the arcuate flexible metal elements removed from the grooves, in accordance with at least one embodiment described herein;

FIG. 4D is a plan view of the illustrative cylindrical body depicted in FIG. 4C, in accordance with at least one embodiment described herein;

FIG. 4E is a side elevation view of the illustrative cylindrical body construction that provides double arcuate flexible metal element rings, in accordance with at least one embodiment described herein;

FIG. 4F is a side elevation view of another illustrative cylindrical body construction that provides a single arcuate flexible metal element ring, in accordance with at least one embodiment described herein;

FIG. 5A is an upper perspective view of an illustrative end cap, in accordance with at least one embodiment described herein;

FIG. 5B is a lower perspective view of the illustrative end cap depicted in FIG. 5A, in accordance with at least one embodiment described herein;

FIG. 5C is another upper perspective view of the illustrative end cap depicted in FIGS. 5A and 5B, in accordance with at least one embodiment described herein;

FIG. 5D is a side perspective view of the illustrative end cap depicted in FIGS. 5A, 5B, and 5C in accordance with at least one embodiment described herein;

FIG. 6A is an elevation view of an illustrative pipeline cleanout tool prior to insertion into a pipeline to be cleaned, in accordance with at least one embodiment described herein;

FIG. 6B is an elevation view of the illustrative pipeline cleanout tool upon insertion into the pipeline to be cleaned, in accordance with at least one embodiment described herein; and

FIG. 6C is an elevation view of the illustrative pipeline cleanout tool removing debris and accretions from the pipeline to be cleaned, in accordance with at least one embodiment described herein.

FIG. 7A is a cross-sectional elevation view of another illustrative pipeline cleanout tool that includes an axially displaceable stabilizer element with a flush connection that, when coupled to a pressurized fluid supply enables the passage of a fluid flush through the stabilizer element, through one or more fluid conduits and across the rotatable cleaning head assembly, in accordance with at least one embodiment described herein;

FIG. 7B is a transverse cross-sectional elevation view of the illustrative axially displaceable stabilizer element depicted in FIG. 7A along sectional line 7B-7B, in accordance with at least one embodiment described herein;

FIG. 7C is a transverse cross-sectional elevation view of the illustrative axially displaceable stabilizer element depicted in FIG. 7A along sectional line 7C-7C, in accordance with at least one embodiment described herein;

FIG. 7D is a transverse cross-sectional elevation view of the illustrative axially displaceable stabilizer element depicted in FIG. 7A along sectional line 7D-7D, in accordance with at least one embodiment described herein;

FIG. 7E is a longitudinal cross-sectional elevation view of the illustrative axially displaceable stabilizer element depicted in FIG. 7A along sectional line 7E-7E, in accordance with at least one embodiment described herein;

FIG. 8A is a rear perspective view of an illustrative flexible metal element that includes at least one tooth disposed in, on, or about at least a portion of the external surface of the arcuate flexible metal element, in accordance with at least one embodiment described herein;

FIG. 8B is another perspective view of the illustrative arcuate flexible metal element depicted in FIG. 8A, in accordance with at least one embodiment described herein;

FIG. 9A is a side elevation of an illustrative pipeline cleanout tool having a rotatable cleaning head assembly that includes a cutting head assembly physically coupled to the first end of the flexible rotatable shaft, in accordance with at least one embodiment described herein;

FIG. 9B is an enlarged side elevation of the cutting head assembly included on the rotatable cleaning head assembly depicted in FIG. 9A, in accordance with at least one embodiment described herein; and

FIG. 9C is a transverse cross-sectional elevation of the illustrative cutting head depicted in FIG. 9B along sectional line 9C-9C, in accordance with at least one embodiment described herein.

Although the following Detailed Description will proceed with reference being made to illustrative embodiments, many alternatives, modifications and variations thereof will be apparent to those skilled in the art.

### DETAILED DESCRIPTION

The apparatuses, systems, and methods described herein provide a pipeline cleanout tool capable of removing built-up accretions within a pipeline in preparation for in-situ reinstatement of the pipeline with a liner material. Over time, solid material, pipeline corrosion products, and other detritus accumulates within a pipeline—this material adheres to the walls of the pipeline restricting flow and increasing pressure drop within the pipeline. In addition, such deposits also form an ideal environment for corrosion within cast iron and steel pipelines. Prior to reinstating the pipeline, these deposits must be reduced or ideally, removed, to restore flow and reduce the pressure drop within the pipeline.

The systems, apparatuses and methods described herein advantageously remove accretions within a pipeline in preparation for reinstatements of the pipeline. Beneficially, unlike prior art cleaning tools, the systems and apparatuses disclosed herein are able to pass through and remove deposits and/or accretions on the walls of damaged sections of pipeline, such as portions of a pipeline in which a longitudinal portion of the pipe wall has been completely removed by corrosion or physical damage, with “falling through” or otherwise hanging-up on the damaged pipeline portion. The systems, methods, and apparatuses disclosed herein use a rotatable cleaning head assembly that includes a plurality of arcuate flexible metal elements that project outward from a cylindrical body included in the rotatable cleaning head. The arcuate flexible metal elements compress to form a continuous ring around the rotatable cleaning head that continuously contacts the interior surface of the pipeline through a full 360° circle. Additionally, some or all of the arcuate flexible metal elements may include an abrasive coating to assist in removing accretions from the interior surface of the pipeline. Further, the cylindrical body may include multiple rows of arcuate flexible metal elements.

The rotatable cleaning head assembly is physically coupled to a flexible rotating shaft that, in operation, rotates the rotatable cleaning head assembly. A force applied to the end of the flexible rotating shaft opposite the rotatable cleaning head assembly causes the rotatable cleaning head assembly to pass through the pipeline, removing buildup and accretions present within the pipeline. Additional elements such as centering elements, stabilizing elements, compressible elements, and/or flexible sleeves may be disposed along the flexible rotating shaft to assist in inserting the rotatable cleaning head assembly into the pipeline and also to assist in navigating the rotatable cleaning head assembly through the pipeline.

A pipeline cleanout tool is provided. The pipeline cleanout tool may include: a flexible shaft having a longitudinal axis, a first end, and a second end; a rotatable cleaning head disposed proximate the first end of the shaft, the rotatable cleaning head including: a first end cap having an aperture formed centrally through a thickness of the first end cap, the aperture to accommodate the passage of the flexible shaft; a second end cap an aperture formed centrally through a thickness of the second end cap, the aperture to accommodate the passage of the flexible shaft; and at least one cylindrical body disposed between the first end cap and the second end cap, the at least one cylindrical body including: an aperture formed centrally through a thickness of the at least one cylindrical body, the aperture to accommodate the passage of the flexible shaft; a first surface having a first plurality of grooves formed therein, each of the first plurality of grooves to accept the insertion of at least one arcuate flexible metal element, each arcuate flexible metal element extending spirally outward from an external surface of the at least one cylindrical body; and a second surface transversely opposed across the thickness of the at least one cylindrical body from the first surface, the second surface having a second plurality of grooves formed therein, each of the second plurality of grooves to accept the insertion of the at least one arcuate flexible metal element, each of the arcuate flexible metal elements extending spirally outward from an external surface of the at least one cylindrical member; at least one spacer element disposed about the flexible shaft; and a compressible element disposed about the flexible shaft and positioned between the rotatable cleaning head and the at least one spacer element, the compressible element compressible along the longitudinal axis of the flexible shaft.

Another pipeline cleanout tool is provided. The tool may include: a flexible shaft having a longitudinal axis, a first end, and a second end; a rotatable cleaning head disposed about the flexible shaft and proximate the first end of the flexible shaft, the rotatable cleaning head including a body having a first radius and including: a plurality of arcuate flexible metal elements extending spirally outward from the body, each of the plurality of arcuate flexible metal elements having a radius of curvature greater than the first radius; at least one spacer element disposed about the flexible shaft between the rotatable cleaning head and the second end of the flexible shaft; and a compressible element disposed about the flexible shaft and positioned between the rotatable cleaning head and the at least one spacer element, the compressible element compressible along the longitudinal axis of the flexible shaft.

A pipeline cleanout head is provided. The pipeline cleanout head may include: a plurality of arcuate flexible metal elements; a cylindrical body having a first radius, a first surface and a second surface transversely opposed across a thickness of the cylindrical body from the first surface, the cylindrical body further including: an aperture formed centrally through a thickness of the cylindrical body, the aperture to accommodate passage of a flexible shaft; a first plurality of grooves formed in the first surface, each of the first plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body; and a second plurality of grooves formed in the second surface, each of the second plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body.

As used herein the term “axial” refers to the longitudinal axis of the flexible shaft of the pipeline reinstatement tool. As used herein, the term “radial” refers to a radius, radial member, or radial distance measured with respect to the longitudinal axis of the flexible shaft of the pipeline reinstatement tool.

As used herein, the term “arcuate” refers to a member, at least a portion of which forms an arced or arched shape. The arc may have a constant radius, a variable radius, a contracting radius, an expanding radius, or any number and/or combination thereof. The arc may have any arc length and/or central angle. As used herein, an arcuate member or a member described as arcuate or arcuate shaped may have a continuous arc or arch, or may include a plurality of segments that are bent or broken to form an arc or arch shape. As used herein, an arcuate member or a member described as arcuate or arcuate shaped may include an arc or arched member having a compound curve, for example a first arc or arch along a longitudinal axis of the member and a second arc or arch along one or more lateral axes of the member.

As used herein, the term “cylindrical” and members referred to as being “cylindrical” refers to right circular cylindrical members. As used herein, the longitudinal axis of a cylindrical member passes through the center of the circular area on each end of the cylindrical member.

As used herein, the term “spherical cap” refers to the region of a sphere which lies above (or below) a given plane. Members referred to as being “spherical cap-shaped” include at least one planar surface and one curved surface. As used herein, the longitudinal axis of a spherical cap-shaped member passes through the center of the circular area on the planar surface of the member and passes through the apex of the curved portion of the spherical cap-shaped member.

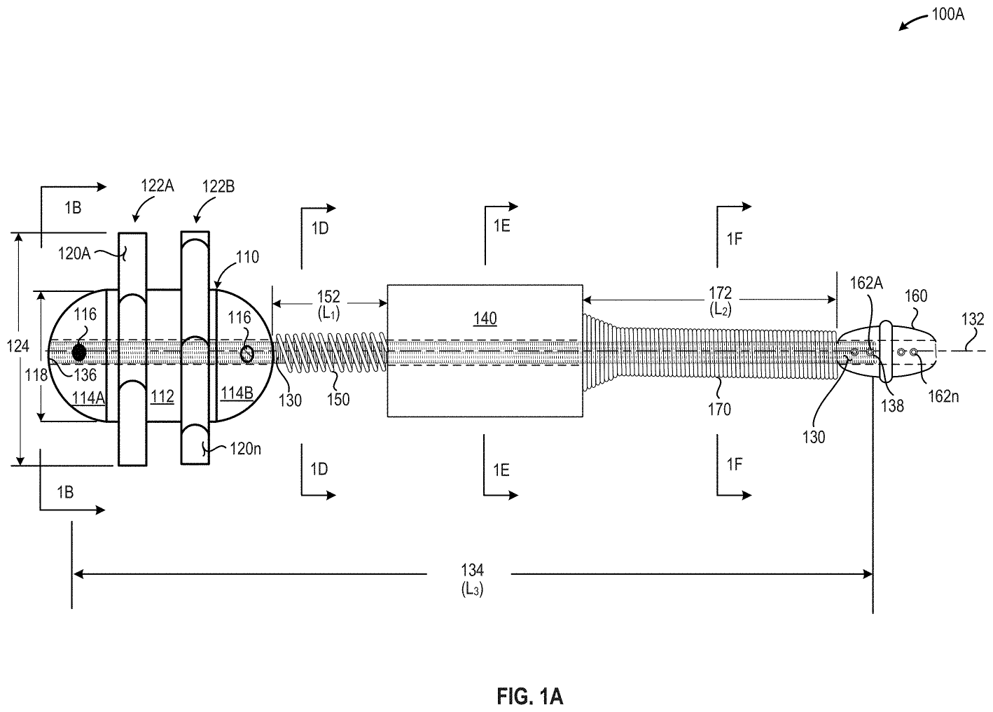

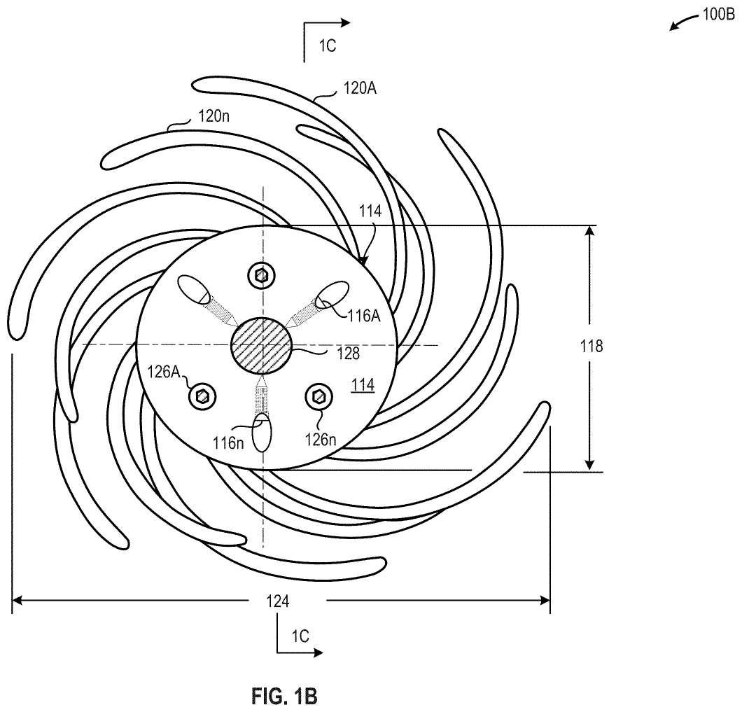

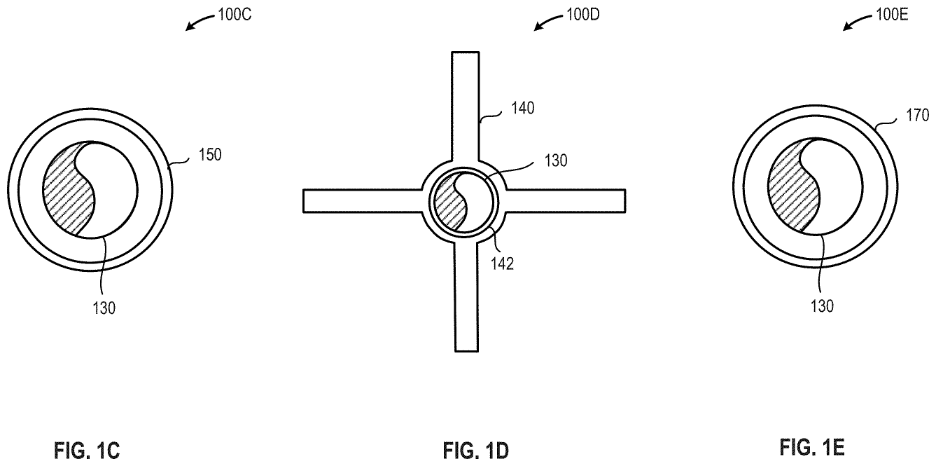

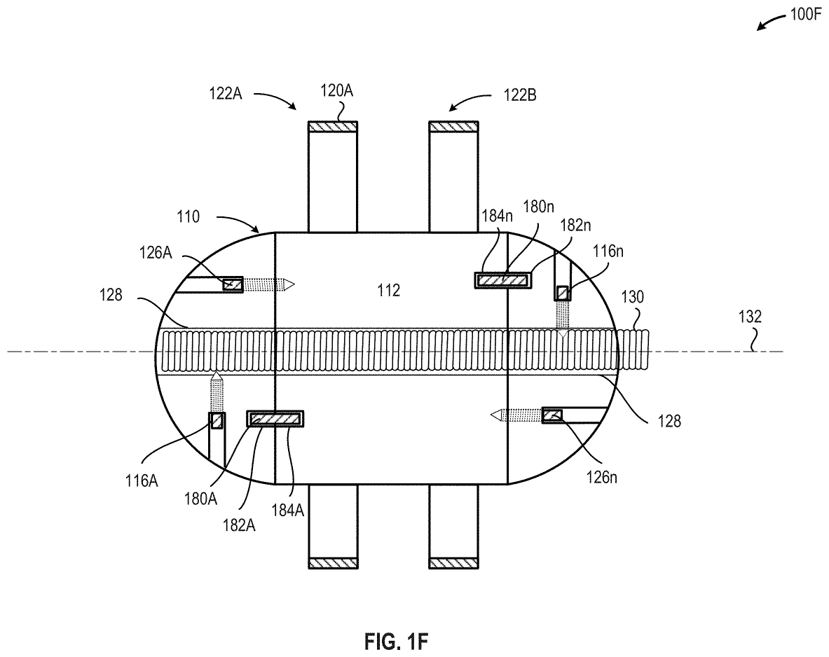

FIG. 1A is an elevation view of an illustrative pipeline cleanout tool 100 that includes a rotatable cleaning head assembly 110 physically coupled to a first end 136 of a flexible rotating shaft 130, at least one stabilizer element 140 slideably disposed about the flexible rotating shaft 130, and at least one compressible element 150 disposed about the flexible rotating shaft 130, at least one flexible sleeve 170 disposed about the flexible rotatable shaft 130, and a coupling element 160 disposed about the flexible rotatable shaft 130 and proximate the second end 138 of the flexible rotatable shaft 130, in accordance with at least one embodiment described herein. FIG. 1B is an elevation view along sectional line 1B-1B of the illustrative rotatable cleaning head assembly 110 that more clearly depicts an illustrative plurality of arcuate flexible metal elements 120A-120n, arranged in one or more rows along the longitudinal axis of the flexible rotating shaft 130 and extending outward from the body of the rotatable cleaning head assembly 110, in accordance with at least one embodiment described herein. FIG. 1C is a cross-sectional elevation of the illustrative rotatable cleaning head assembly 110 along sectional line 1C-1C as depicted in FIG. 1B, in accordance with at least one embodiment described herein. FIG. 1D is a cross-sectional elevation along sectional line 1D-1D that depicts the at least one compressible element 150 disposed about the flexible rotating shaft 130, in accordance with at least one embodiment described herein. FIG. 1E is a cross-sectional elevation along sectional line 1E-1E that depicts the at least one stabilizer element 140 disposed about the flexible rotating shaft 130, in accordance with at least one embodiment described herein. FIG. 1F is a cross-sectional elevation along sectional line 1F-1F that depicts the at least one flexible sleeve 170 disposed about the flexible rotating shaft 130, in accordance with at least one embodiment described herein.

Referring first to FIGS. 1A, 1B and 1C, the rotatable cleaning head assembly 110 is physically coupled proximate the first end of the flexible rotatable shaft 130. In embodiments, the rotatable cleaning head assembly 110 may be detachably attached to the first end 136 of the flexible rotatable shaft 130. The rotatable cleaning head assembly 110 may be fabricated as a multi-piece assembly that includes a cylindrical body 112 having a first end surface and a second end surface. A first end cap 114A may be disposed proximate the first end surface of the cylindrical body 112 and a second end cap 114B disposed proximate the second end surface of the cylindrical body 112. A plurality of fasteners 116A-116n (collectively, “fasteners 116”) in each of the first end cap 114A and second end cap 114B serve to physically couple the rotatable cleaning head assembly 110 to the first end of the flexible rotating shaft 130. In embodiments, loosening or removal of the fasteners 116 may permit the detachable attachment of the rotatable cleaning head assembly 110 from the first end of the flexible rotatable shaft 130. The rotatable cleaning head assembly 110 may have a diameter 118 selected based on the size or diameter of the pipeline to be cleaned. For example, the diameter 118 of the rotatable cleaning head assembly 110 may range from about 50% to about 80% of the inside diameter of the pipeline to be cleaned. The longitudinal length (i.e., the length measured along the longitudinal axis 132 of the flexible rotatable shaft 130) of the rotatable cleaning head assembly 110 may vary based on the number of rows of arcuate flexible metal elements 120 carried by the rotatable cleaning head assembly 110. The rotatable cleaning head assembly 110 may be fabricated using one or more materials. In embodiments, the one or more materials may include one or more corrosion resistant materials such as aluminum, aluminum containing alloys, stainless steel alloys, bronze, bronze containing alloys, brass, brass containing alloys, polymeric materials (HDPE and similar, carbon fiber reinforced composites, and similar. In embodiments, the cylindrical body 112 may have a diameter 118 of: from about 0.5 inches (in.) to about 1 in.; from about 1 in. to about 2 in.; from about 2 in. to about 3 in.; from about 3 in. to about 4 in.; from about 4 in. to about 5 in.; from about 5 in. to about 6 in.; from about 6 in. to about 7 in.; from about 7 in. to about 8 in.; from about 8 in. to about 10 in.; from about 10 in. to about 12 in.; from about 12 in. to about 16 in.; from about 16 in. to about 20 in.; from about 20 in. to about 24 in.; or from about 24 in. to about 36 in.

As more clearly depicted in FIG. 1B, a plurality of arcuate flexible metal elements 120A-120n (collectively, “arcuate flexible metal elements 120”) project in a spiral pattern from the external surface of the rotatable cleaning head assembly 110. In embodiments, the arcuate flexible metal elements 120 may be grouped or otherwise arranged to provide a first row 122A of arcuate flexible metal elements 120A-120n and a second row 122B of arcuate flexible metal elements 120A-120n. The arcuate flexible metal element rows 122A and 122B may be positioned at different locations along the longitudinal axis 132 of the flexible rotatable shaft 130 and extend from the external surface of the cylindrical body 112. Although two arcuate flexible metal element rows 122A and 122B are depicted in FIGS. 1A and 1B, one will readily appreciate that any number of similar rows 122A-122n containing any number of arcuate flexible metal elements 120A-120n may be similarly positioned along the longitudinal axis 132 of the cylindrical body 110. The arcuate flexible metal element rows 122A-122n may be evenly or unevenly spaced along the longitudinal axis 132 of the flexible rotatable shaft 130.

Each of the arcuate flexible metal elements 120 extends spirally outward from the external surface of the cylindrical body 112 portion of the rotatable cleaning head assembly 110. In embodiments, each of the arcuate flexible metal elements 120 included in a given row 122 may extend the same distance from the cylindrical body 112 or may extend a different distance from the cylindrical body (i.e., each of the arcuate flexible metal elements 120 included in any given row 122 may have the same or a different arc length). The diameter 124 of the uncompressed arcuate flexible metal elements 120 is greater than the inside diameter of the pipeline to be cleaned such that when compressed the arcuate flexible metal elements 120 are inserted into the pipeline, the arcuate flexible metal elements 120 expand to contact the interior perimeter of the pipeline, thereby facilitating the removal of accretions and accumulated debris within the pipeline. For example the diameter 124 of the uncompressed arcuate flexible metal elements 120 may range from about 110% to about 150% of the inside diameter of the pipeline to be cleaned.

FIG. 1B provides a plan view of an example end cap 114 and FIG. 1C provides a cross sectional elevation of an illustrative rotatable cleaning head assembly 110. Since the first end cap 114A and the second end cap 114B are symmetric, a plurality of fasteners 126A-126n (collectively, “fasteners 126”) physically couple the first end cap 114A to the first end surface of the cylindrical body 112. In the embodiment depicted in FIG. 1C, the fasteners 126 may include threaded fasteners such as cap screws or similar. Similarly, a plurality of fasteners 126 may physically couple the second end cap 114B to the second end surface of the cylindrical body 112. Referring to FIG. 1C, in embodiments, a plurality of sockets 182A-182n may be formed or otherwise disposed on, about or across the planar surface of the first end cap 114A and a corresponding plurality of sockets 184A-184n may be formed or otherwise disposed on, about or across the first surface of the cylindrical body 112. Pins 180A-180n or similar members may be disposed in each respective one of the plurality of sockets 182A-182n/184A-184n to further minimize or prevent differential rotation between the first end cap 114A and the cylindrical body 112. Similarly, a plurality of sockets 182A-182n may be formed or otherwise disposed on, about or across the planar surface of the second end cap 114B and a corresponding plurality of sockets 184A-184n may be formed or otherwise disposed on, about or across the second surface of the cylindrical body 112. The first end cap 114A and the second end cap 114B may each include an aperture 128 formed through the center of the respective end cap 114A and 114B that is sized to permit the passage of the flexible rotatable shaft 130.

In embodiments, the end caps 114 may have a diameter similar or identical to the diameter of the cylindrical body 112. The end caps 114 may be fabricated from one or more metals or metal compositions, such as aluminum, aluminum alloys, stainless steel alloys, carbon steel alloys, brass alloys, bronze alloys or similar. In embodiments, the diameter of the end caps 114 may be based, at least in part, on the inside diameter of the pipeline to be cleaned.

The flexible rotatable shaft 130 may include any currently available and/or future developed rotatable shaft having a first end to which the rotatable cleaning head assembly 110 physically couples and a second end to physically couple to a rotating driver system. The flexible rotatable shaft 130 may have any diameter. For example, the flexible rotatable shaft 130 may have a diameter of from about 0.25 inches to about 1.00 inches. In embodiments, the diameter of the flexible rotatable shaft 130 may be selected based upon the diameter of the pipeline to be cleaned—for example, larger pipelines may require the use of a relatively larger diameter flexible rotatable shaft 130 to communicate sufficient torque to the rotatable cleaning head assembly 110 than smaller diameter pipelines. In embodiments, the flexible rotatable shaft 130 may include a spiral wound flexible rotatable shaft 130. The flexible rotatable shaft 130 may have any shaft length (L₃) 134. In embodiments, the flexible rotatable shaft 130 may have a shaft length (L₃) 134 of: about 6 in. or less; about 8 in. or less; about 10 in. or less; about 12 in. or less; about 16 in. or less; about 20 in. or less; about 24 in. or less; about 28 in. or less; about 32 in. or less; about 36 in. or less; about 40 in. or less; about 44 in. or less; or about 48 in. or less.

Referring next to FIGS. 1A and 1D, the at least one spacer element 140 may include one or more elements disposed along the longitudinal axis of the flexible rotatable shaft 130. Although depicted as an four-lobed, open, ovoid spacer element 140 is depicted in FIG. 1A, the at least one spacer element 140 may have any physical geometry. The at least one spacer element 140 includes an aperture formed through and/or along the longitudinal axis of the spacer element 140 that is sized to permit the passage of the flexible rotatable shaft 130 and allows the spacer element 140 to freely rotate about the flexible rotatable shaft 130. In embodiments, the at least one spacer element 140 may include a plurality of spacer elements 140A-140n, at least a portion of which may be positioned either proximate each other. In embodiments, the at least one spacer element 140 may include a plurality of spacer elements 140A-140n, at least a portion of which may be separated by any number and/or combination of compressible elements (e.g., helical springs) and/or flexible sleeves disposed along the longitudinal axis of the flexible rotatable shaft 130. The at least one spacer element 140 may be fabricated using any material or combination of materials. For example, the at least one spacer element 140 may be fabricated using carbon steel, stainless steel, brass, bronze, aluminum, or combinations and/or alloys thereof. The diameter of the at least one spacer element 140 may have any physical dimensions. For example at least one spacer element 140 may have a diameter that is less than or equal to the diameter of the rotatable cleaning head assembly 110.

Referring next to FIGS. 1A and 1C, the at least one compressible element 150 may be disposed along and about the flexible rotatable shaft 130 between the rotatable cleaning head assembly 110 and the spacer element 140. The at least one flexible sleeve 170 may be disposed along and about the flexible rotatable shaft 130 between the coupling element 160 and the spacer element 140. The flexible rotatable shaft 130 has a first end 136 and a second end 138. The at least one compressible element 150 may have a first length (L₁) 152 and the at least one flexible sleeve 170 may have a second length (L₂) 172. In some embodiments, the first length (L₁) 152 and the second length (L₂) 172 may be similar or the same. In other embodiments, the flexible sleeve 170 may have a second length (L₂) 172 that is greater than the first length (L₁) 152 of the compressible element 150.

The at least one compressible element 150 may include any number and/or combination of currently available and/or future developed systems or structures capable of providing a resistance against a compressive force applied along the longitudinal axis 132 of the flexible rotatable shaft 130. The at least one compressible element 150 may be fabricated using any number and/or combination of materials including but not limited to: stainless steel alloys, carbon steel alloys, bronze alloys, brass alloys, elastomers, carbon fiber reinforced materials, or combinations thereof. As depicted in FIG. 1A, in at least some embodiments, the at least one compressible element 150 may include one or more helical metal springs. The at least one compressible element 150 may have any value spring constant (k₁). In embodiments, the at least one compressible element 150 may have a spring constant value based on the inside diameter of the pipeline to be cleaned. For example, a compressible element 150 may have a relatively higher spring constant for larger pipelines and a relatively lower spring constant for smaller pipelines. In embodiments, the at least one compressible element 150 may have a spring constant value proportional to the inside diameter of the pipe to be cleaned. For example, the compressible element 150 may have a spring constant value of: about 1 lb_{f}/in or greater; about 2 lbd/in or greater; about 3 lb_{f}/in or greater; about 5 lbd/in or greater; about 10 lbd/in or greater; or about 20 lb_{f}/in or greater. The compressible element 150 may have a first length (L₁) 152 of about: 10% or more; 15% or more; 20% or more; 25% or more; 30% or more; 35% or more; 40% or more; or 45% or more of the flexible rotatable shaft length (L₃) 134.

Referring next to FIGS. 1A and 1E, the at least one flexible sleeve 170 may include any number and/or combination of currently available and/or future developed systems or structures capable of increasing the stiffness of the flexible rotatable shaft 130 along the longitudinal axis of the flexible rotatable shaft 130. The at least one flexible sleeve 170 may be fabricated using any number and/or combination of materials including but not limited to: stainless steel alloys, carbon steel alloys, bronze alloys, brass alloys, elastomers, carbon fiber reinforced materials, or combinations thereof. In embodiments, the at least one flexible sleeve 170 may include one or more flexible non-compressible elements, one or more flexible compressible elements, or any number and/or combination thereof. As depicted in FIG. 1A, in at least some embodiments, the at least one flexible sleeve 170 may include one or more tightly wound, tapered, helical metal springs. Where the at least one flexible sleeve 170 includes one or more compressible elements, the one or more compressible elements may have any value spring constant (k₂). Where the at least one flexible sleeve 170 includes one or more compressible elements, the one or more compressible elements may have a spring constant (k₂) that is the same as or greater than the spring constant (k₁) of the at least one compressible member 150. The flexible sleeve 170 may have a second length (L₂) 172 of about: 10% or more; 15% or more; 20% or more; 25% or more; 30% or more; 35% or more; 40% or more; 45% or more; 50% or more; 60% or more; 70% or more; 80% or more; or 90% or more of the flexible rotatable shaft length (L₃) 134.

In operation, the arcuate flexible metal elements 120 are compressed to fit within the bore of the pipeline to be cleaned. In embodiments, the arcuate flexible metal elements 120 may be manually compressed or the rotatable cleaning head assembly 110 may be passed through a reducer or similar fitting fitted to the end of the pipeline to be cleaned. The spacer element 140 may be slidably displaced along the longitudinal axis 132 of the flexible rotatable shaft 130, compressing the compressible element 150 between the spacer member 140 and the rotatable cleaning head assembly 110. The force applied to the rotatable cleaning head assembly 110 causes the rotatable cleaning head assembly to enter the pipeline to be cleaned. An external force is applied to the flexible rotatable shaft 130 along the longitudinal axis of the flexible rotatable shaft 130 to drive the rotatable cleaning head assembly 110 through the pipeline to be cleaned. The compressed arcuate flexible metal elements 120 form a continuous ring about the rotatable cleaning head assembly 110 and maintain contact with the inner surface or bore of the pipeline to be cleaned. In embodiments, the compressed arcuate flexible metal elements 120 may form a plurality of rings 122A-122n about the rotatable cleaning head assembly 110 and maintain contact with the inner surface or bore of the pipeline to be cleaned.

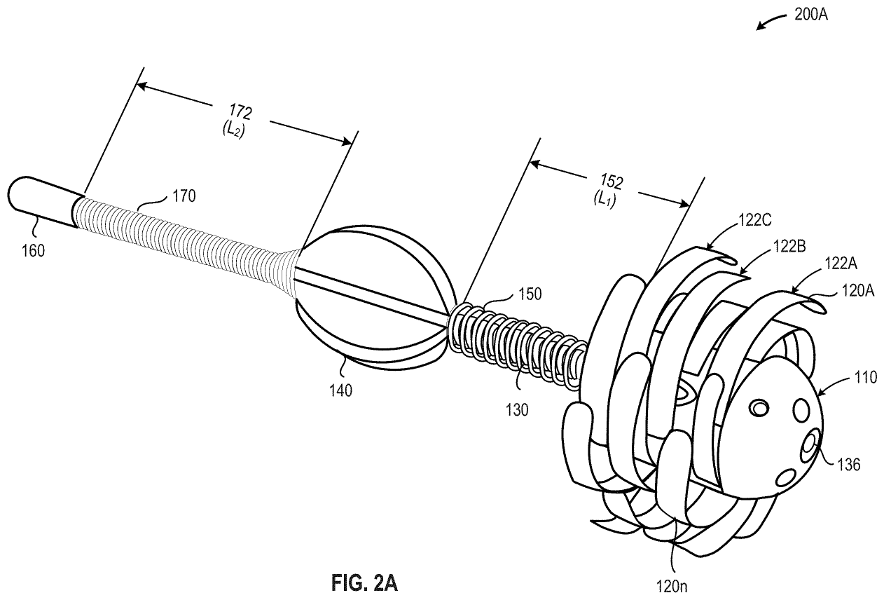

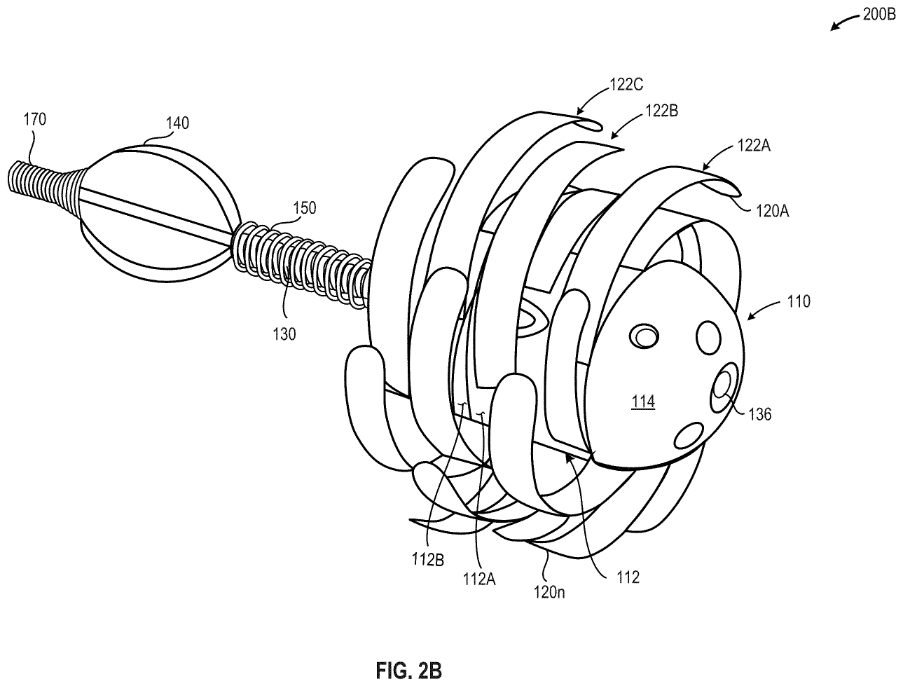

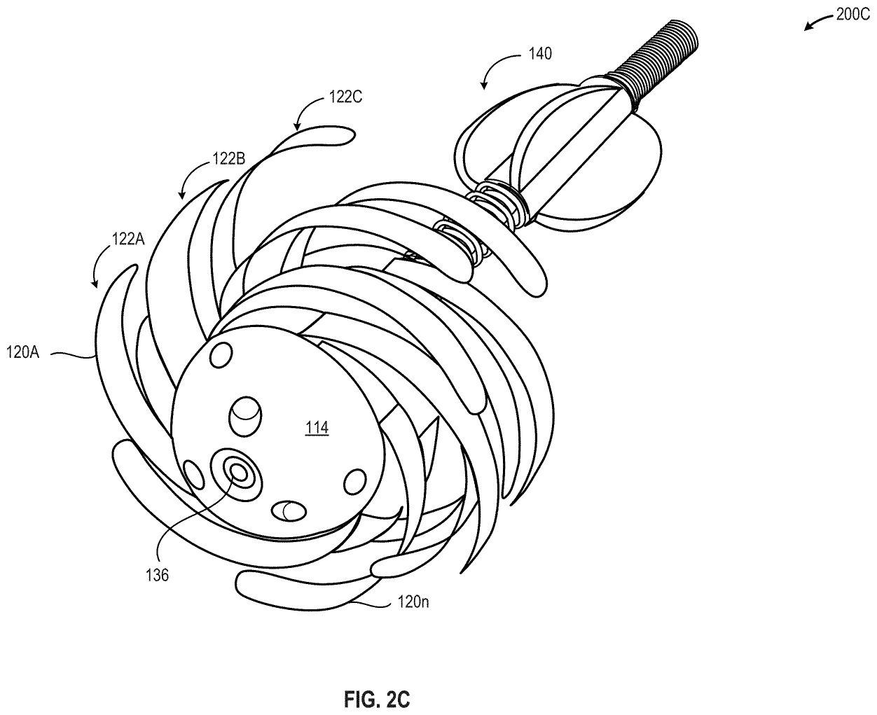

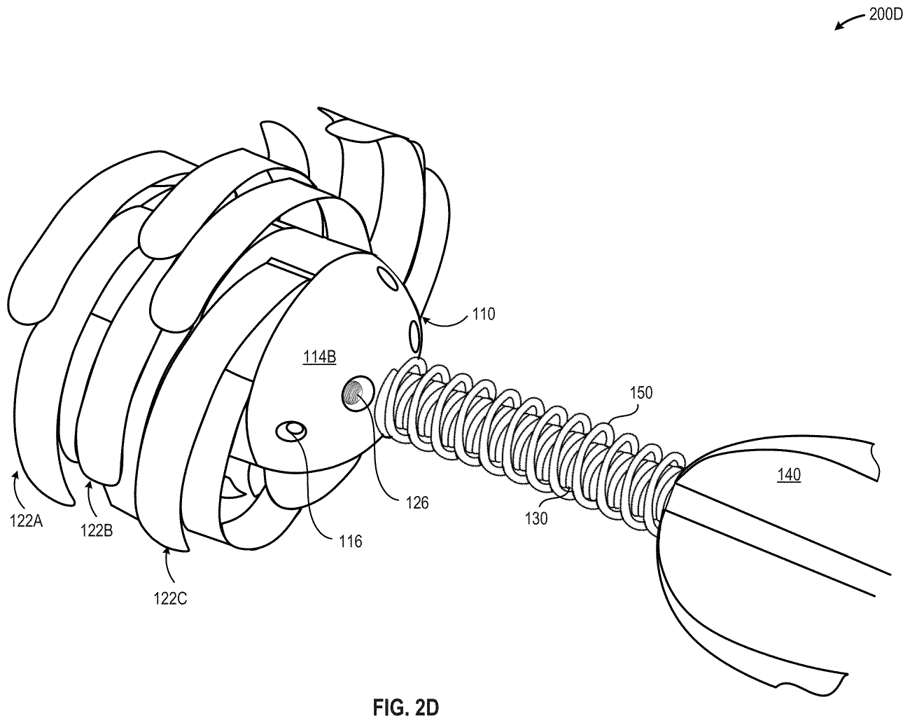

FIG. 2A is a perspective view of an illustrative pipeline cleanout tool 200 that includes a rotatable cleaning head assembly 110 physically coupled to the first end 136 of a flexible rotatable shaft 130, a spacer element 140 disposed at an intermediate location along the flexible rotatable shaft 130, and a coupling element 160 disposed proximate the second end 138 of the flexible rotatable shaft 130, in accordance with at least one embodiment described herein. FIG. 2B is a close-up perspective view of the rotatable cleaning head assembly 110 included in the illustrative pipeline cleanout tool 200 depicted in FIG. 2A, in accordance with at least one embodiment described herein. FIG. 2C is another close-up perspective view of the rotatable cleaning head assembly 110 included in the illustrative pipeline cleanout tool 200 depicted in FIG. 2A, in accordance with at least one embodiment described herein. FIG. 2D is a reverse close-up perspective view of the rotatable cleaning head assembly 110 included in the illustrative pipeline cleanout tool 200 depicted in FIG. 2A, in accordance with at least one embodiment described herein.

As depicted in FIGS. 2A-2D, the rotatable cleaning head assembly 110 includes arcuate flexible metal elements 120A-120n arranged in three arcuate flexible metal element rings 122A, 122B, and 122C extending from the cylindrical body 112 and positioned at different locations along the longitudinal axis 132 of the flexible rotatable shaft 130. Although not visible in FIGS. 2A-2D, the cylindrical body 112 is a multi-pieces structure that includes a first cylindrical body 112A from which arcuate flexible metal element rings 122A and 122B extend and a second cylindrical 112B body disposed proximate the first cylindrical body 112A from which arcuate flexible metal element ring 122C extends. Each of the arcuate flexible metal element rings 122A, 122B, and 122C include six arcuate flexible metal elements 120A-120F. The arcuate flexible metal elements 120A-120F forming each arcuate flexible metal element ring 122A-122C may be evenly (i.e., at 60° angles with respect to each other) or unevenly spaced (i.e., at two or more different angles with respect to each other) about the periphery of the cylindrical body 112.

As depicted in FIGS. 2A-2D, the arcuate flexible metal elements 120A-120F forming arcuate flexible metal element ring 122A extending from the first cylindrical body 112A may be offset from the arcuate flexible metal elements 120A-120F forming arcuate flexible metal element 122B extending from the first cylindrical body 112A. Although not visible in FIGS. 2A-2D, in the first cylindrical body 112A may be rotationally coupled to the second cylindrical body 112B using one or more pins or similar connecting elements fitted into receiving apertures disposed in corresponding locations on the mating surfaces of the first cylindrical body 112A and second cylindrical body 112B. In a similar manner, the cylindrical body 112 may include any number of component or constituent cylindrical bodies 112A-112n.

As depicted in FIGS. 2A-2D, the at least one spacer element 140 may include a single, open, ovoid spacer element 140 disposed along the flexible rotatable shaft 130 between the at least one compressible element 150 and the at least one flexible sleeve 170. Although depicted as an ovoid spacer element in FIGS. 2A-2D, the at least one spacer element 140 may have any size, shape, or physical geometry. In embodiments, the at least one spacer element 140 may include a structure having a plurality of constituent or component spacer elements 140A-140n.

In embodiments, the at least one spacer element 140 may include a plurality of constituent or component spacer elements 140A-140n, at least a portion of which may be separated from one or more adjacent spacer elements by one or more compressible elements and/or one or more flexible sleeves.

A plurality of fasteners 116A-116n physically couple the first end cap 114A to the flexible rotatable shaft 130. The plurality of fasteners 116A-116n may include any number, type, and/or combination of fasteners capable of physically coupling the first end cap 114A to the flexible rotatable shaft 130. In the embodiment depicted in FIG. 2A the plurality of fasteners 116A-116n includes a plurality of threaded one or more threaded fasteners, such as one or more hex-head cap screws or similar. A plurality of fasteners 126A-126n physically couple the first end cap 114A to the cylindrical member 112. In such embodiments, removal of the plurality of fasteners 126A-126n coupling the first end cap 114A to the cylindrical body 116 and loosening or removal of the plurality of fasteners 116A-116n coupling the first end cap 114A to the flexible rotatable shaft 130 will permit the removal of the first end cap 114A from the flexible rotatable shaft 130. Removal of the plurality of fasteners 126A-126n coupling the second end cap 114B to the cylindrical member 112 permits the separation of the cylindrical member 112 from the flexible rotatable shaft 130.

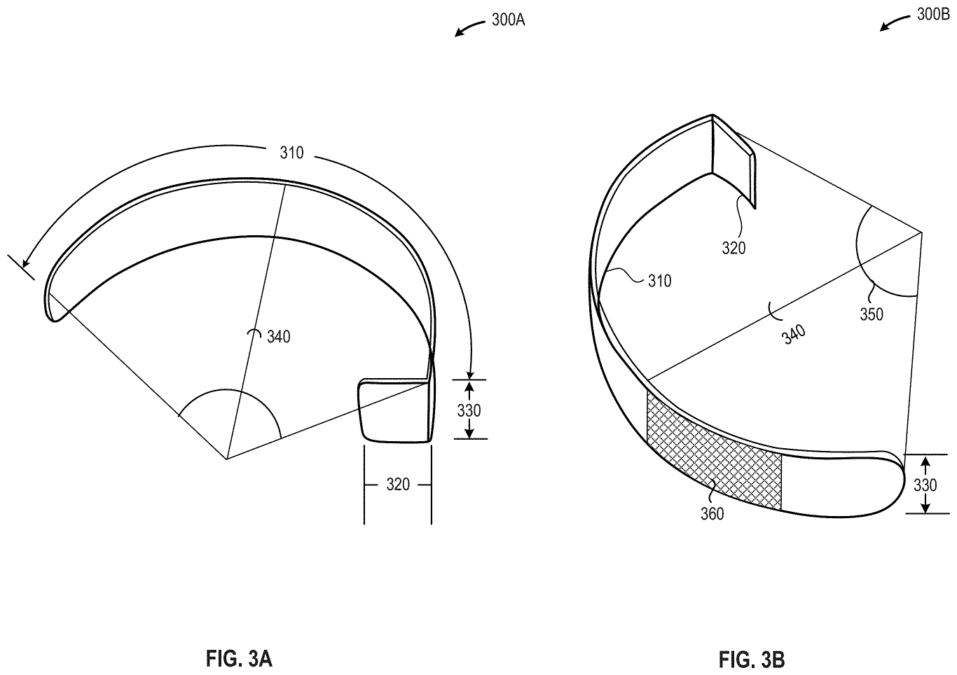

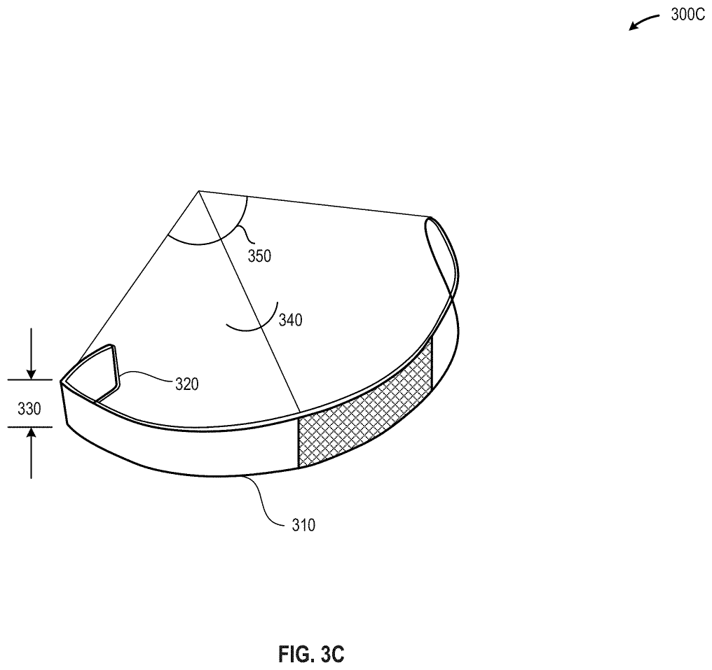

FIG. 3A is a perspective view of an illustrative arcuate flexible metal element 120, in accordance with at least one embodiment described herein. FIG. 3B is another perspective view of the illustrative arcuate flexible metal element 120 depicted in FIG. 3A, in accordance with at least one embodiment described herein. FIG. 3C is yet another perspective view of the illustrative arcuate flexible metal element 120 depicted in FIGS. 3A and 3B, in accordance with at least one embodiment described herein.

Each of the arcuate flexible metal elements 120 include an arcuate portion 310 and a lock portion 320. At least a portion of the arcuate portion 310 extends from the cylindrical body 112 and the lock portion 320 retains the arcuate portion within the cylindrical body 112. The arcuate portion 310 has a radius 340 and an arc length. The lock portion 320 may include a straight section that extends a distance 322 from the arcuate portion 310. Although the lock portion 320 is depicted in FIGS. 3A-3C as a straight section, other physical geometries (curved, arcuate, coiled etc.) may be used to form all or a portion of the lock portion 320. The arcuate flexible metal element 120 may be fabricated using one or more metals having a thickness sufficient to permit the arcuate flexible metal elements 120A-120n that form a arcuate flexible metal element ring 122 to overlap such that a ring 122 having a continuous perimeter is formed by overlapping at least a portion of each arcuate flexible metal element 120 over at least one neighboring arcuate flexible metal element 120.

The radius 340 of the arcuate portion 310 of each arcuate flexible metal element 120 may be based, at least in part, on the diameter 118 of the cylindrical body 112. The arc length of the arcuate portion 310 of each arcuate flexible metal elements 120 may be based, at least in part, on the diameter 118 of the cylindrical body 112. In embodiments, the arc length of the arcuate portion 310 of each of the arcuate flexible metal elements 120 may be determined by the angle 350 subtended by the arcuate portion 310. The angle 350 subtended by the arcuate portion 310 of each of the arcuate flexible metal elements 120 may range: from about 20° to about 180°; from about 40° to about 160°; from about 45° to about 135°; from about 60° to about 120°; from about 75° to about 110°; or from about 80° to about 105°. In embodiments, the terminus of the arcuate portion 310 of each of some or all of the plurality of arcuate flexible metal elements 120 may be radiused as depicted in FIGS. 3A-3C. In other embodiments, the terminus of the arcuate portion 310 of each of some or all of the plurality of arcuate flexible metal elements 120 may have any physical geometry, such as square, triangular, multi-pronged, and similar.

Each of the arcuate flexible metal elements 120A-120n may be formed using a metal demonstrating spring-like properties such as spring steel or spring stainless steel. As depicted in FIGS. 3B and 3C, in some embodiments, an abrasive material and/or coating 360 may be disposed in, on, about, or across at least a portion of the outer surface of the arcuate portion 310 of each of the arcuate flexible metal elements 120 such that, when compressed the abrasive material forms a ring of abrasive material 360 about the arcuate flexible metal element ring 122.

In embodiments, an abrasive material and/or coating 360 may be disposed in, on, about, or across at least a portion of the outer surface of the arcuate portion 310 of each of the arcuate flexible metal elements 120 such that, when compressed, the abrasive material 360 forms a continuous ring of abrasive material 360 about the arcuate flexible metal element ring 122. Such an abrasive ring 122 beneficially expedites the removal of solids and/or other accretions within the pipeline to be cleaned. The abrasive material 360 may include one or more abrasive material including but not limited to compounds that include or contain one or more of the following abrasives: aluminum oxide, boron nitride, boron carbide, ceramic alumina, diamond, silicon carbide, tungsten carbide, or zirconium. The abrasive material 360 may provide a surface having any one or more of the following abrasive grits: 40 grit or higher; 60 grit or higher; 120 grit or higher; or 200 grit or higher.

Each of the plurality of arcuate flexible metal elements 120A-120n may have the same or a different width 330. For example, each of the plurality of arcuate flexible metal elements 120A-120n may have a width of about: 0.25 inches (in.) or less; 0.375 in. or less; 0.50 in. or less; 0.625 in. or less; 0.75 in. or less; 0.875 in. or less; 1.00 in. or less; 1.25 in. or less; 1.50 in. or less; 1.75 in. or less; or 2.00 in. or less. Each of the plurality of arcuate flexible metal elements 120A-120n may have the same or a different thickness. For example, each of the plurality of arcuate flexible metal elements 120A-120n may have a thickness of about: 10 gauge ( 9/64″) or thinner; 16 gauge ( 1/16″) or thinner; 20 gauge ( 3/80″) or thinner; or 28 gauge ( 1/64″) or thinner.

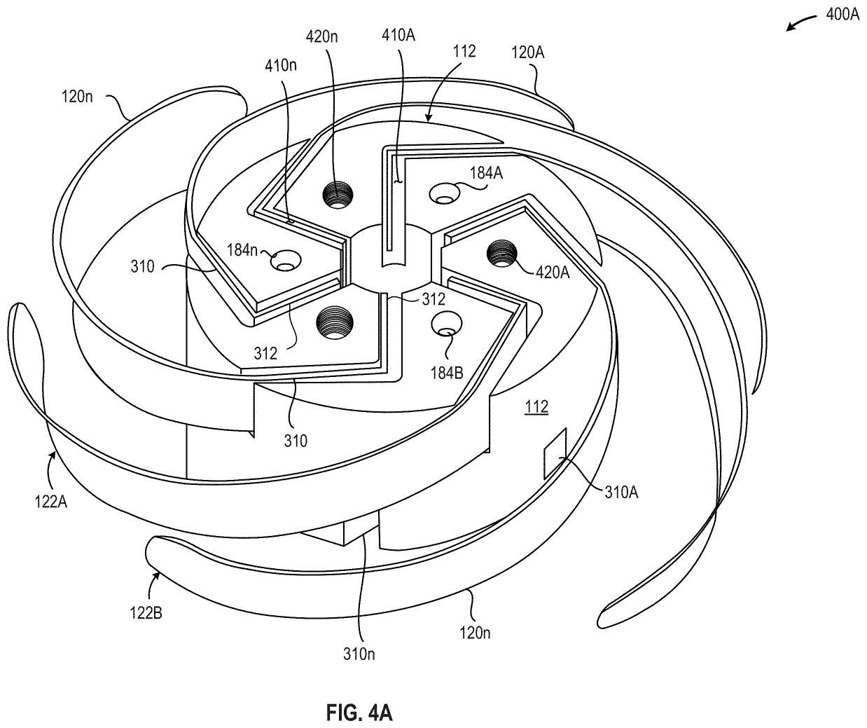

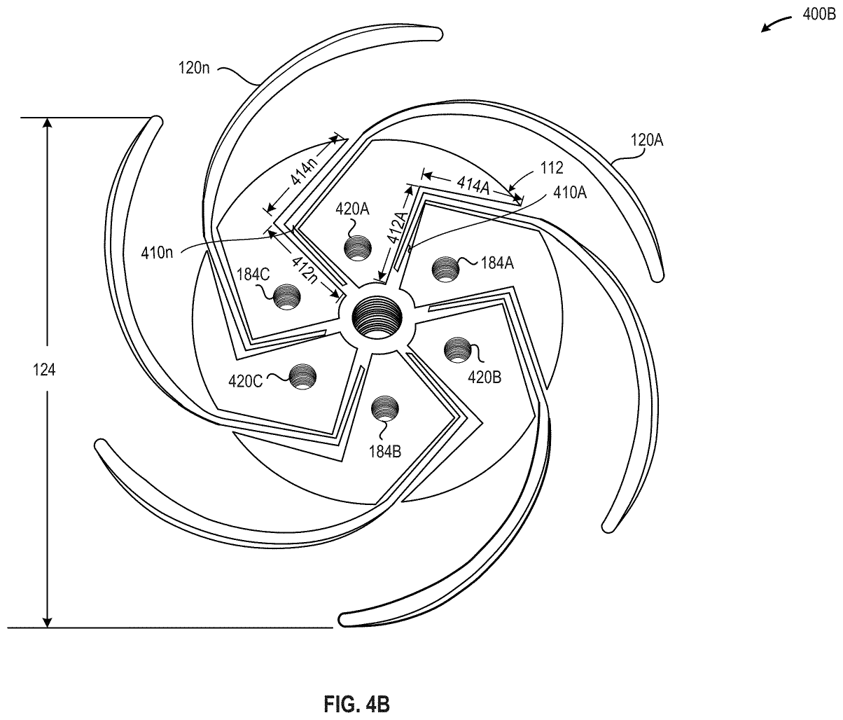

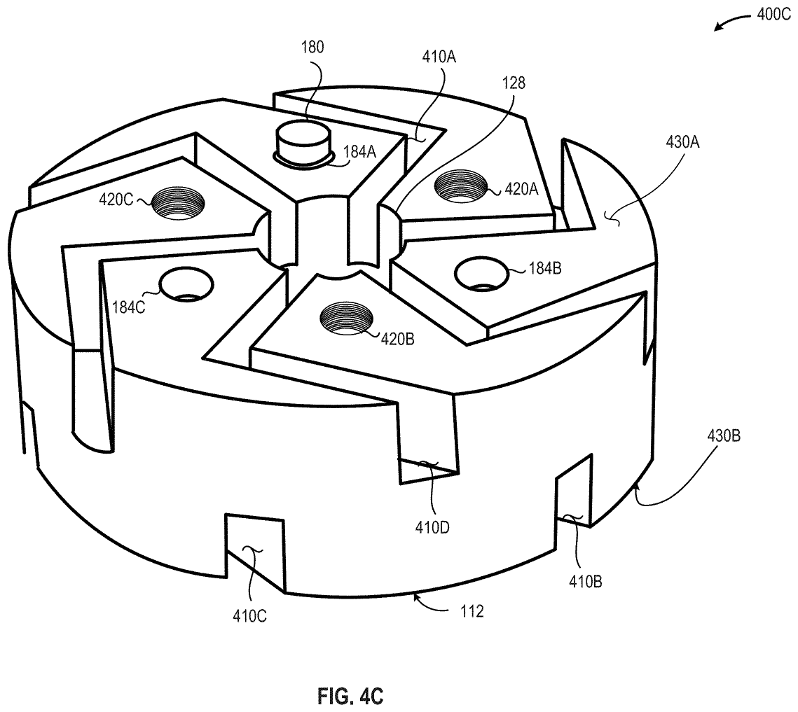

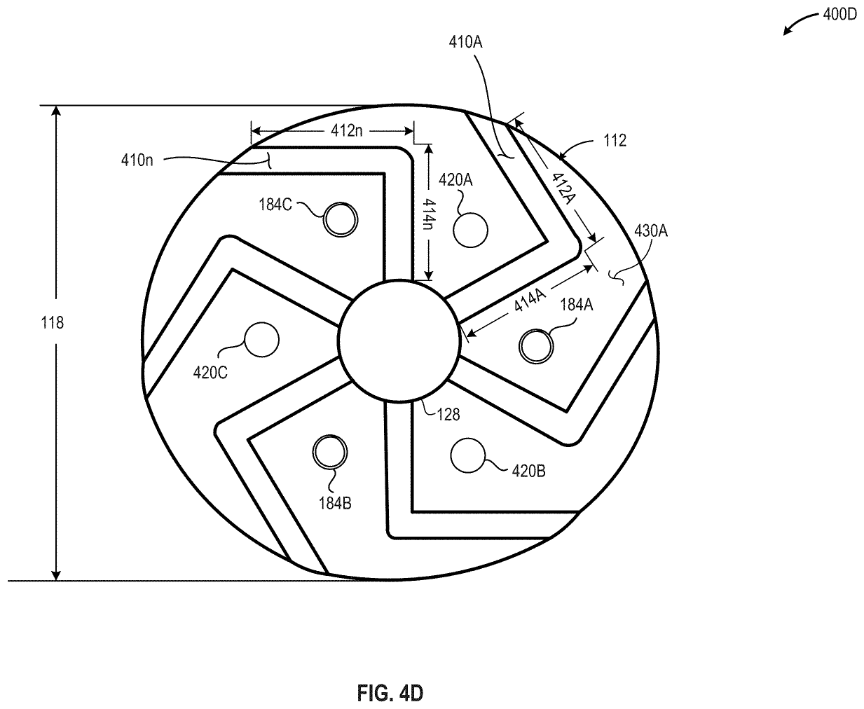

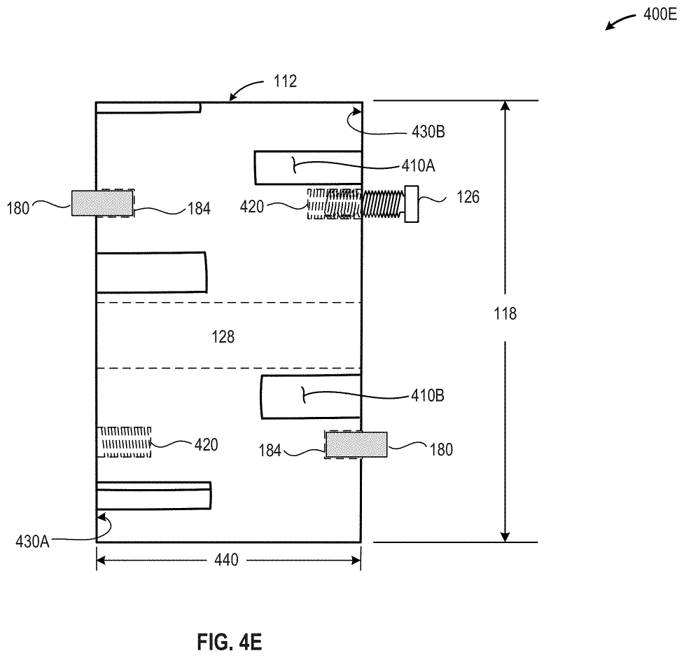

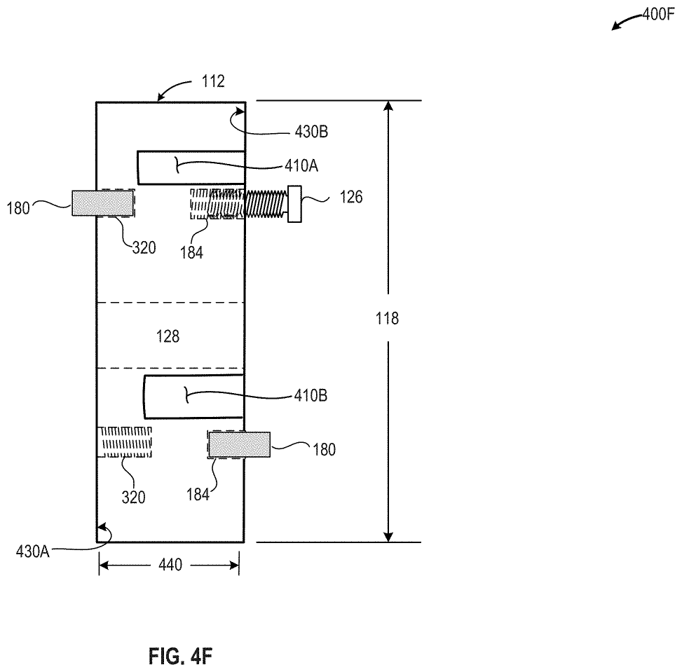

FIG. 4A is a perspective view of an illustrative cylindrical body 112 that includes a plurality of grooves 410A-410n (collectively, “grooves 410”) to accept the slideable insertion of at least one arcuate flexible metal element 120, in accordance with at least one embodiment described herein. FIG. 4B is a plan view of the illustrative cylindrical body 112 depicted in FIG. 4A, in accordance with at least one embodiment described herein. FIG. 4C is a perspective view of an illustrative cylindrical body 112 with the arcuate flexible metal elements 120 removed from the grooves 410, in accordance with at least one embodiment described herein. FIG. 4D is a plan view of the illustrative cylindrical body 112 depicted in FIG. 4C, in accordance with at least one embodiment described herein. FIG. 4E is a side elevation view of the illustrative cylindrical body 112 that provides double arcuate flexible metal element rings 122A, 122B as depicted in FIG. 4C and FIG. 4D, in accordance with at least one embodiment described herein. FIG. 4F is a side elevation view of another illustrative cylindrical body 112 that provides a single arcuate flexible metal element ring 122, in accordance with at least one embodiment described herein.

Referring first to FIGS. 4A and 4B, the cylindrical body 112 includes a first end surface and a second end surface. The first end surface of the cylindrical body 112 includes a plurality of grooves 410A-410n and the second end surface of the cylindrical body 112 includes a plurality of grooves 410A-410n. The number of grooves 410 formed in the first end surface of the cylindrical member 112 may be the same or different than the number of grooves 410 formed in the second end surface of the cylindrical member 112. Each of the grooves 410A-410n includes a respective lock portion 412A-412n (collectively, “lock portions 412”) and a respective arcuate flexible metal element holder portion 414A-414n (collectively, “holder portions 414”). The lock portion 412A-412n of each respective one of the grooves 410A-410n receives the lock portion 320A-320n of respective ones of the plurality of arcuate flexible metal elements 120A-120n. The geometry of the lock portion 412A-412n prevents the expulsion of the arcuate flexible metal elements 120 when the rotatable cleaning head assembly 110 is in operation.

Although the lock portion 412 is depicted as a straight section in FIGS. 4A and 4B, the physical geometry of the lock section 412 may be altered or changed to correspond to the lock portion 320 of the arcuate flexible metal elements 120. For example, the lock portion 412 may have a circular, arcuate, or oval physical geometry to match a similar physical geometry of the lock portion 310 of each respective one of the plurality of arcuate flexible metal elements 120.

In embodiments, the depth of each of some or all of the grooves 410 may be equal to the width 330 of the arcuate flexible metal element 120 positioned in the respective groove 410. In other embodiments, the depth of each of some or all of the grooves 410 may be less than the width 330 of the arcuate flexible metal element 120 positioned in the respective groove 410.

In embodiments, the dimensions (width and depth) of each of the plurality of grooves 410 may be continuous or may vary. In some embodiments, the width and depth of a groove 410 may be the same across all of the lock portion 412 and holder portion 414 forming the respective groove. In other embodiments, the width and/or depth of the lock portion 412 may differ from the width and/or depth of the holder portion 414. In embodiments, each of the grooves 410 may have a depth of about: 0.25 inches (in.) or less; 0.375 in. or less; 0.50 in. or less; 0.625 in. or less; 0.75 in. or less; 0.875 in. or less; 1.00 in. or less; 1.25 in. or less; 1.50 in. or less; 1.75 in. or less; or 2.00 in. or less. In embodiments, each of the grooves 410 may have a width of about: 0.125 inches (in.) or less; about 0.25 in. or less; about 0.375 in. or less; about 0.50 in. or less; about 0.625 in. or less; about 0.75 in. or less; about 0.875 in. or less; or about 1.00 in. or less.

A plurality of sockets 184A-184C (collectively, “sockets 184”) are disposed across the first end surface of the cylindrical body 112. Pins 180 inserted into each of the sockets 184 minimize or prevent differential rotation between the cylindrical body 112 and an adjacent cylindrical body 112 or end cap 114. Although only three (3) sockets 184 are depicted in FIGS. 4A and 4B, any number of sockets 184 may be disposed in, on, across, or about the first end surface and/or the second end surface of the cylindrical body 112. Although not visible in FIGS. 4A and 4B, a plurality of sockets 184 are disposed in, on, about, or across all or a portion of the second end surface of the cylindrical body 112. Each of the sockets included in the plurality of sockets 184 may have the same or different diameter and/or depth. In embodiments, each of the sockets 184 may have a diameter of about: 0.125 inches (in.) or less; 0.25 in. or less; 0.375 in. or less; 0.50 in. or less; or 1.00 in. or less.

A plurality of female threaded apertures 420A-420C (collectively, “threaded apertures 420”) are also disposed in, on, about, or across the first end surface 430A of the cylindrical body 112. Fasteners inserted into each of the threaded apertures 420 physically affix the cylindrical body 112 to an adjacent end cap 114. Although only three (3) threaded apertures 420 are depicted in FIGS. 4A and 4B, any number of threaded apertures 420A-420n may be disposed in, on, across, or about the first end surface 430A and/or the second end surface 430B of the cylindrical body 112. Although not visible in FIGS. 4A and 4B, a plurality of threaded apertures 420A-420n may be disposed in, on, about, or across all or a portion of the second end surface 430B of the cylindrical body 112. Each of the female threaded apertures included in the plurality of threaded apertures 420 may have the same or different thread pitch, diameter, and/or depth.

The cylindrical body 112 may be fabricated using one or more corrosion resistant materials and/or alloys. In embodiments, the cylindrical body 112 may be fabricated using aluminum or an aluminum containing alloy, a stainless steel alloy, bronze, brass, or similar metallic materials. In other embodiments, the cylindrical body may be cast or molded using one or more polymeric of carbon-fiber containing, non-metallic composites. The cylindrical body 112 includes an centrally located aperture 128 to accommodate the passage of the flexible rotatable shaft 130 therethrough. The diameter 118 of the cylindrical body 112 may be selected based, at least in part, on the inside diameter of the pipeline to be cleaned.

Referring next to FIGS. 4C, 4D, and 4E, the cylindrical body 112 is depicted without arcuate flexible metal elements 120A-120n inserted. As depicted in FIGS. 4C, 4D, and 4E, a plurality of grooves 410A-410n may be formed in the first end surface 412A and a plurality of grooves 410A-410n may be formed in the second end surface 412B. The cylindrical body 112 has a diameter 118 and a height 440. The cylindrical body 112 may have any height 440. In embodiments, the cylindrical body 112 may have a height based, at least in part, on the width of the arcuate flexible metal elements 120A-120n. In embodiments, the cylindrical body 112 may have a height 440 of about: 0.5 inches (in.) or less; 0.75 in. or less; 1.00 in. or less; 1.25 in. or less; 1.5 in. or less; 2.0 in. or less; 3.0 in. or less; 4.0 in. or less; 6.0 in. or less; or 8.0 in. or less. As depicted in FIGS. 4D and 4E, a pin 180 is inserted into one of the sockets 184 disposed on the first end surface 412A of the cylindrical body 112.

In embodiments, the cylindrical body 112 may have a plurality of grooves formed in either the first end surface 412A or the second end surface 412B so as to provide a single arcuate flexible metal element ring 112. In embodiments, the cylindrical body 112 may include a plurality of constituent cylindrical bodies 112A-112n that are pinned or otherwise prevented from differential rotation. Thus a rotatable cleaning head assembly 110 may include any number of constituent cylindrical bodies 112A-112n providing any number of arcuate flexible metal element rings 122A-122n.

Referring to FIG. 4F, the cylindrical body 112 may have a first end surface 430A that includes a plurality of grooves 410A-410n and a second end surface 430B that does not include grooves, thereby providing a single arcuate flexible metal element ring 122 extending from the exterior surface of the cylindrical body 112. In embodiments, the rotatable cleaning head assembly 110 may include any number and/or combination of single arcuate flexible metal element ring 122 cylindrical bodies 112A-112n and/or double arcuate flexible metal element rings 122A, 122B cylindrical bodies 112A-112n.

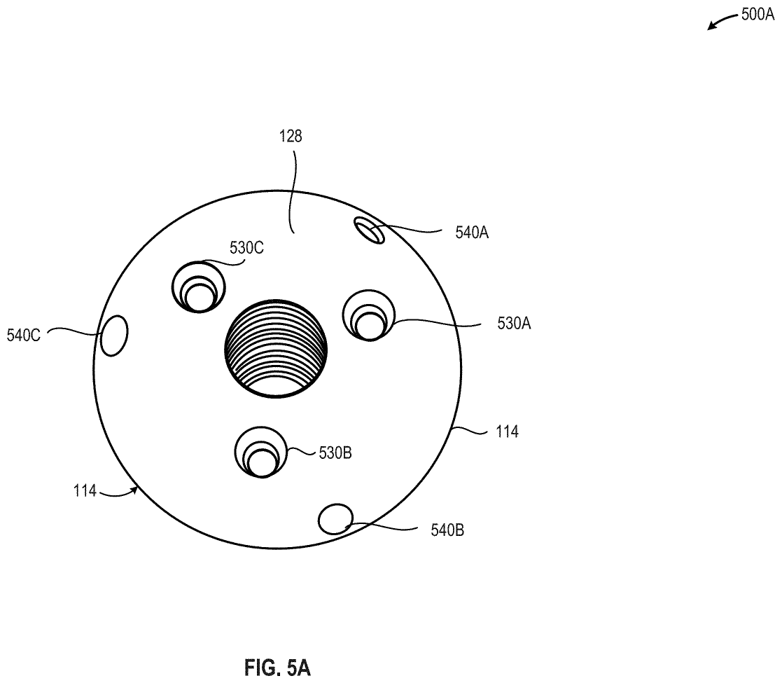

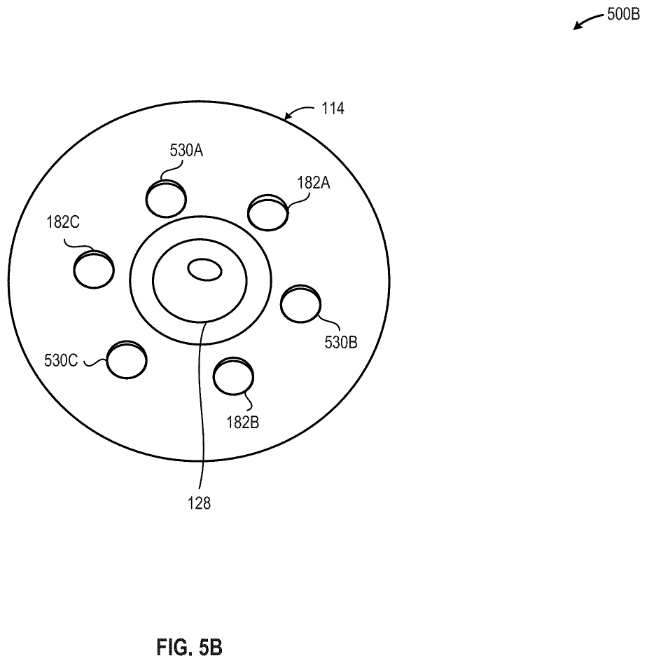

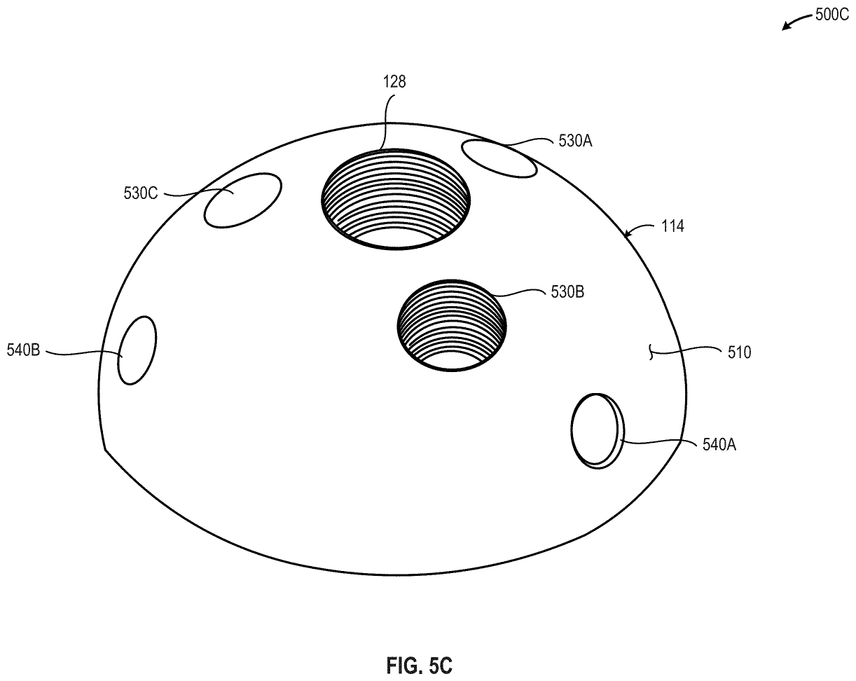

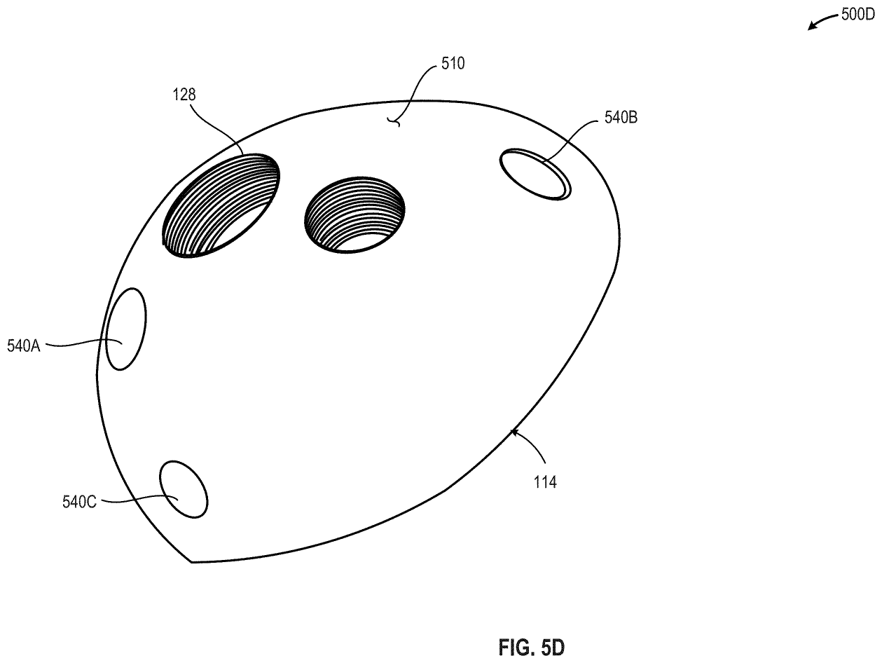

FIG. 5A is an upper perspective view of an illustrative end cap 114, in accordance with at least one embodiment described herein. FIG. 5B is a lower perspective view of the illustrative end cap 114 depicted in FIG. 5A, in accordance with at least one embodiment described herein. FIG. 5C is another upper perspective view of the illustrative end cap 114 depicted in FIGS. 5A and 5B, in accordance with at least one embodiment described herein. FIG. 5D is a side perspective view of the illustrative end cap 114 depicted in FIGS. 5A, 5B, and 5C in accordance with at least one embodiment described herein.

Referring to FIGS. 5A-5D, the end cap includes an upper surface 510 and a lower surface 520. In embodiments, the lower surface 520 may have a planar surface that may be disposed proximate the first end surface 412A or the second end surface 412B. Although depicted as a spherical section in FIGS. 5A-5D, the upper surface 510 of the end cap 114 may have any physical geometry, such as pyramidal, conical, frusto-conical, and similar. An aperture 128 to accommodate the passage of the flexible rotatable shaft 130 may be centrally formed through the longitudinal axis of the end cap 114. In embodiments, the end cap 114 may provide either or both the first end cap 114A and/or the second end cap 114B.

As depicted in FIGS. 5A-5D, a plurality of female threaded apertures 530A-530C (collectively, “female threaded apertures 530”) may be disposed in, on, about, or across at least a portion of the upper surface 510 of the end cap 114. In embodiments, each of the plurality of female threaded apertures 530 may be disposed parallel to the longitudinal axis 132 of the flexible rotatable shaft 130. Although only three (3) female threaded apertures 530 are depicted in FIGS. 5A-5D, any number of similar female threaded apertures 530 may be disposed in, on, about, or across the upper surface 510 of the end cap 114. In embodiments, each of the plurality of female threaded apertures 530A-530C receive a threaded female threaded fastener 126A-126C to physically couple the end cap 114 to the adjacent cylindrical body 112.

As depicted in FIGS. 5A-5D, a plurality of female threaded apertures 540A-540C (collectively, “female threaded apertures 540”) may be disposed in, on, about, or across at least a portion of the upper surface 510 of the end cap 114. In embodiments, each of the plurality of female threaded apertures 540 may be disposed radially outward and normal to the longitudinal axis 132 of the flexible rotatable shaft 130. Although only three (3) female threaded apertures 540 are depicted in FIGS. 5A-5D, any number of similar female threaded apertures 540 may be disposed in, on, about, or across the upper surface 510 of the end cap 114. In embodiments, each of the plurality of female threaded apertures 540A-540C receive a threaded female threaded fastener 116A-116C to physically couple the end cap 114 to the flexible rotatable shaft 130.

The end cap 114 may be fabricated using one or more corrosion resistant materials and/or alloys. In embodiments, the end cap 114 may be fabricated using aluminum or an aluminum containing alloy, a stainless steel alloy, bronze, brass, or similar metallic materials. In other embodiments, the cylindrical body may be cast or molded using one or more polymeric of carbon-fiber containing, non-metallic composites. The end cap 114 includes an centrally located aperture 128 to accommodate the passage of the flexible rotatable shaft 130 therethrough. The diameter 118 of the end cap 114 may be selected based, at least in part, on the inside diameter of the pipeline to be cleaned.

With specific reference to FIG. 5B, a plurality of sockets 182A-182C (collectively, “sockets 184”) are disposed, in, on, about, or across at least a portion of the lower surface 530 of the end cap 114. Pins 180 may be inserted into each of the sockets 182 minimize or prevent differential rotation between the end cap 114 and an adjacent cylindrical body 112. Although only three (3) sockets 182 are depicted in FIG. 5B, any number of sockets 182 may be disposed in, on, across, or about at least a portion of the lower surface 530 of the end cap 114. Each of the sockets 182 included in the plurality of sockets 182A-182n may have the same or different diameter and/or depth. In embodiments, each of the sockets 182 may have a diameter of about: 0.125 inches (in.) or less; 0.25 in. or less; 0.375 in. or less; 0.50 in. or less; or 1.00 in. or less.

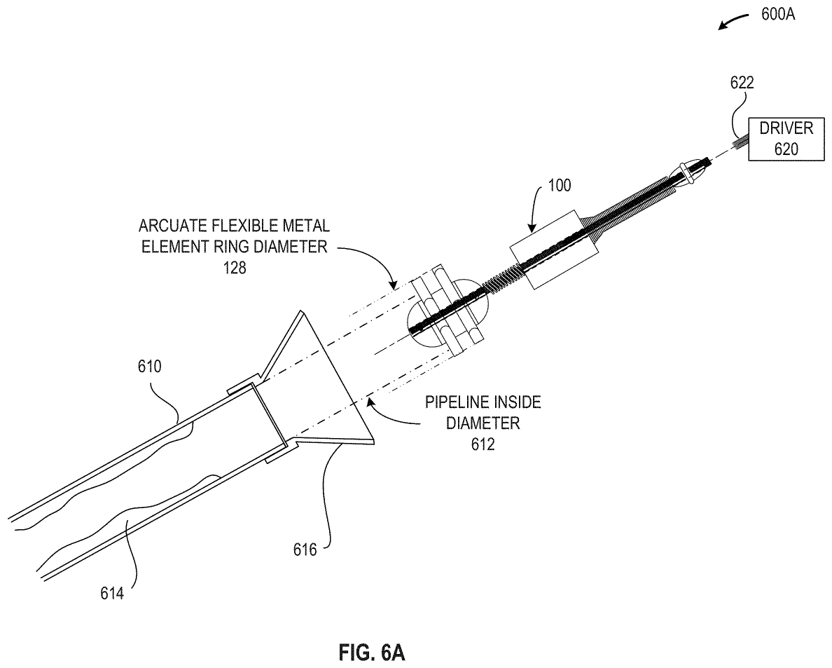

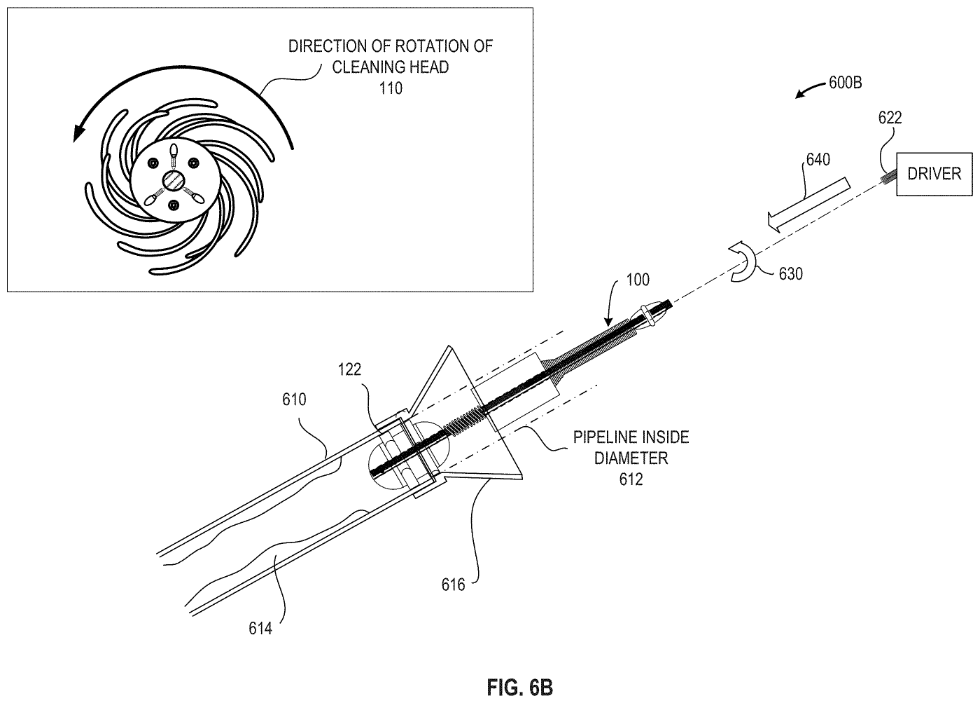

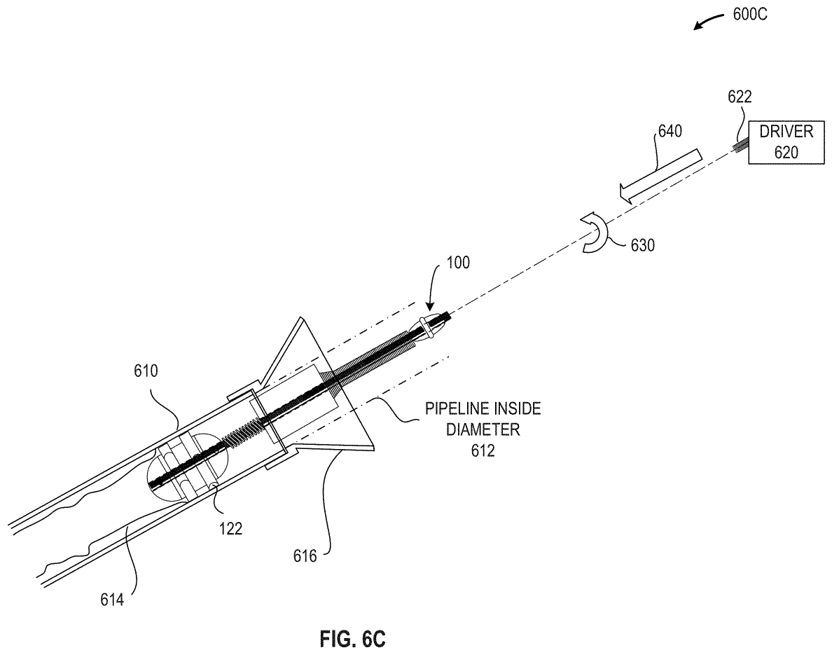

FIG. 6A is an elevation view of an illustrative pipeline cleanout tool 100 prior to insertion into a pipeline to be cleaned 610, in accordance with at least one embodiment described herein. FIG. 6B is an elevation view of the illustrative pipeline cleanout tool 100 upon insertion into the pipeline to be cleaned 610, in accordance with at least one embodiment described herein. FIG. 6C is an elevation view of the illustrative pipeline cleanout tool 100 removing debris and accretions from the pipeline to be cleaned 610, in accordance with at least one embodiment described herein.

In operation, the coupling element 160 couples the flexible rotatable shaft 130 of the pipeline cleanout tool 100 to an flexible shaft rotated by an external driver 620. With reference to FIG. 6A, note the external diameter 128 of the arcuate flexible metal element rings 122 is greater than the inside diameter 612 of the pipeline to be cleaned 610. As depicted in FIG. 6A, deposits and/or accretions 614 are present within the pipeline. These deposits and/or accretions reduce the inside diameter of the pipeline 610, reducing flow and increasing pressure drop through the pipeline. As depicted in FIG. 6A, in at least some embodiments, a concentric reducer 616, such as a conic or bell reducer, may be coupled to the pipeline to assist in reducing the diameter of the arcuate flexible metal element ring(s) 122 to match the inside diameter of the pipeline 610. The pipeline cleanout tool 100 is introduced to the pipeline 610 via the concentric reducer 616. A system operation applies a force along the longitudinal axis 132 of the flexible rotatable shaft 130 to “force” the pipeline cleanout tool 100 into the pipeline.

Referring next to FIG. 6B, the arcuate flexible metal elements 120A-120n compress within the pipeline 610, with each row of arcuate flexible metal elements 120A-120n forming an arcuate flexible metal element ring 122. The pipeline cleanout tool 100 may have any number of such arcuate flexible metal element rings 122A-122n—for example, a pipeline cleanout tool may have two, three, four, or even more arcuate flexible metal element rings 122A-122n.

Advantageously, since each of the arcuate flexible metal elements 120 in each of the arcuate flexible metal element rings 122 is formed using a spring-like material, at least a portion of the external surface of each of the arcuate flexible metal elements 120 maintains intimate contact with the interior surface of the pipeline 610 and/or the surface of the deposits/accretions on the inner surface of the pipeline 610. The addition of an abrasive material 360 on at least a portion of the external surface of some or all of the arcuate flexible metal elements 120A-120n in some or all of the arcuate flexible metal element rings further enhances the capability of the pipeline cleanout tool to quickly and thoroughly remove the deposits/accretions from the inner surface of the pipeline 610. Note in FIG. 6B that the external diameter of the arcuate flexible metal element rings 122 now closely corresponds to the inner surface of the pipeline 610. Application of a force along the longitudinal axis 132 of the flexible rotatable shaft 130 “drives” the pipeline cleanout tool 100 through the pipeline 610. In such a manner pipelines of virtually any length may be cleaned.

Advantageously, the pipeline cleanout tool 100 rotates at high speed (e.g., 1,000 RPM or greater) and the arcuate flexible metal element rings 122A-122n maintain contact with the inner surface of the pipeline 610. The gyroscopic forces produced by the relatively heavy rotating pipeline cleanout tool 100 and the continuous contact between one or more arcuate flexible metal element ring(s) 122A-122n and the inner surface of the pipeline 610 permits the pipeline cleanout tool 100 to beneficially and advantageously “skim” or “skate” across portions of the pipeline 610 where some or all of the pipe sidewall is damaged or even missing without “hanging up” in the damaged portion of the pipeline 610. Conventional tools using chains or wire brushes typically bind and hang up within the damaged section of pipeline, thus the pipeline cleanout tool 100 as described herein offers significant advantages over such devices.

Referring to FIG. 6C, the pipeline cleanout tool 100 has begun to remove the deposits or accretions from the inside wall of the pipeline 610. In embodiments, the driver 620 causes the pipeline cleanout tool 100 to rotate within the pipeline 610 and the compressed arcuate flexible metal elements 120A-120n create one or more arcuate flexible metal element rings 122A-122n that contact the inside surface of the pipeline 610 removing the accumulated debris and accretions from the pipeline 610.

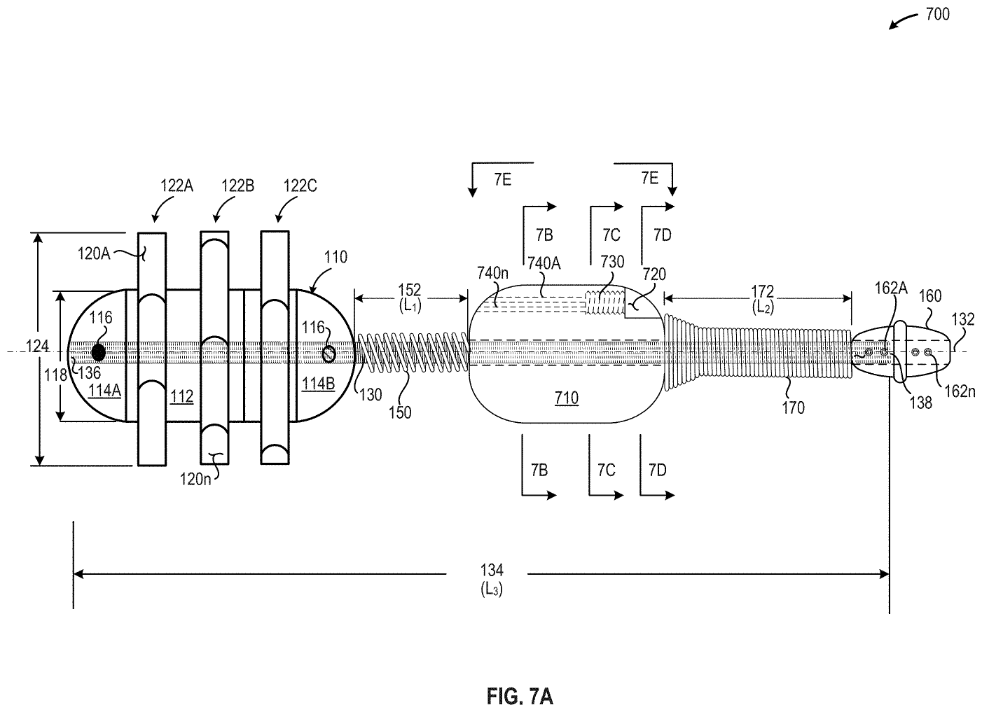

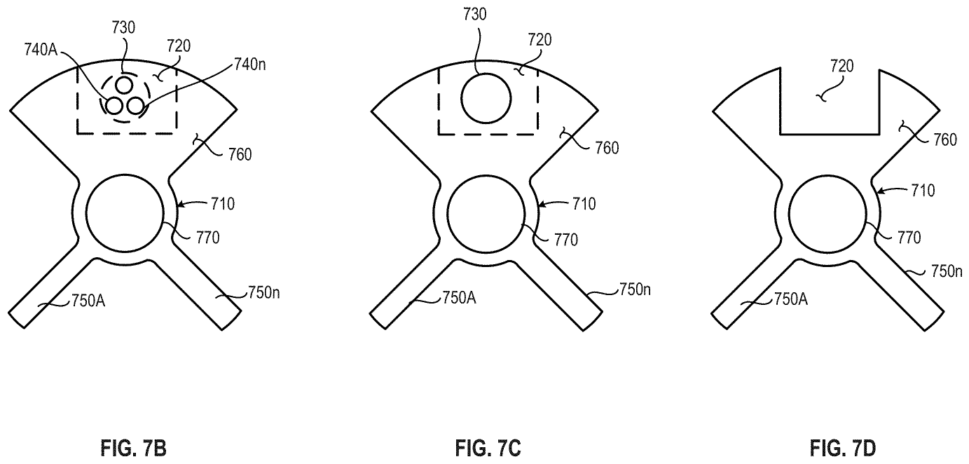

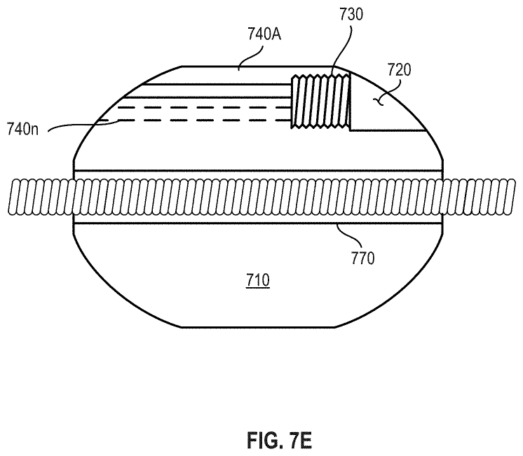

FIG. 7A is a cross-sectional elevation view of another illustrative pipeline cleanout tool 700 that includes an axially displaceable stabilizer element 710 with a flush connection 730 that, when coupled to a pressurized fluid supply enables the passage of a fluid flush through the stabilizer element 710, through one or more fluid conduits 740A-740n (collectively, “fluid conduits 740”) and across the rotatable cleaning head assembly 110, in accordance with at least one embodiment described herein. FIG. 7B is a transverse cross-sectional elevation view of the illustrative axially displaceable stabilizer element 710 depicted in FIG. 7A along sectional line 7B-7B, in accordance with at least one embodiment described herein. FIG. 7C is a transverse cross-sectional elevation view of the illustrative axially displaceable stabilizer element 710 depicted in FIG. 7A along sectional line 7C-7C, in accordance with at least one embodiment described herein. FIG. 7D is a transverse cross-sectional elevation view of the illustrative axially displaceable stabilizer element 710 depicted in FIG. 7A along sectional line 7D-7D, in accordance with at least one embodiment described herein. FIG. 7E is a longitudinal cross-sectional elevation view of the illustrative axially displaceable stabilizer element 710 depicted in FIG. 7A along sectional line 7E-7E, in accordance with at least one embodiment described herein.

In embodiments, it is beneficial to pass a flush fluid (e.g., a liquid or gas flush fluid) across the rotatable cleaning head assembly 110 to assist in the displacement of the debris and/or accretions removed from a pipeline by the rotatable cleaning head assembly 110. Removal of such loosened debris and/or accretions beneficially eases the insertion and/or retraction of the rotatable cleaning head assembly to/from a pipeline 610. As depicted in FIGS. 7A-7E, in some embodiments, the stabilizer element 710 includes a plurality of lobes 750A-750n (collectively, “lobes 750” affixed, formed integral with, or otherwise coupled to a central member having annular aperture formed therethrough to permit the passage of the flexible shaft 130. In such embodiments, the stabilizer element 710 may include one or more “flush through” lobes 760 that include a void space 720, a fluid flush supply connection 730, and one or more fluid conduits 740A-740n (collectively, “fluid conduits 740”). A fluid supply source may be coupled to the flush supply connection 730. A flush fluid flows through the fluid conduits 740 and discharges towards the rotatable cleaning head assembly 110. Although the stabilizer element 710 is depicted as having a plurality of lobes 750 and a single flush through lobe 760, the stabilizer element 710 may include a greater or lesser number of lobes 750 and/or a greater number of flush through lobes 760. In other embodiments, the stabilizer element 710 may include a solid body (cylindrical, ovoid, spherical, etc.) having one or more fluid flush supply connections 730 and any number of fluid conduits 740. As depicted in FIGS. 7A-7E, the stabilizer element 710 includes a void space 720 to provide a flat surface for the fluid flush supply connection 730. In some embodiments, the void space 720 may be eliminated and the fluid flush supply connection 730 disposed in, on, or about the external surface of the stabilizer element 710.

In embodiments, the stabilizer element 710 may have any physical dimensions and/or geometry. The stabilizer element 710 may be used in combination with one or more spacer elements 140 that are disposed along the flexible rotatable shaft 130 between the stabilizer element 710 and the second end 136 of the flexible rotatable shaft 130. The stabilizer element 710 includes an aperture 770 formed through and/or along the longitudinal axis of the stabilizer element 710. The aperture 770 may be sized to permit the passage of the flexible rotatable shaft 130 and allows the stabilizer element 710 to freely rotate about the flexible rotatable shaft 130. In embodiments, the stabilizer element 710 may be disposed along a portion of the flexible rotatable shaft 130 in combination with at least one spacer element 140 that may be separated from the stabilizer element 710 by any number and/or combination of compressible elements (e.g., helical springs) and/or flexible sleeves disposed along the longitudinal axis of the flexible rotatable shaft 130. The stabilizer element 710 may be fabricated using any material or combination of materials. For example, the stabilizer element 710 may be fabricated using carbon steel, stainless steel, brass, bronze, aluminum, or combinations and/or alloys thereof. In embodiments, the stabilizer element 710 may be fabricated using one or more non-metallic materials such as carbon fiber and/or high density polyethylene (HDPE). The diameter of the stabilizer element 710 may be selected based on the inside diameter of the pipeline 610 to be cleaned. In other embodiments, the stabilizer element 710 may have a diameter that is less than or equal to the diameter 118 of the rotatable cleaning head assembly 110. In embodiments, the stabilizer element 710 may have an outside diameter of about: 90% or less; 80% or less; 70% or less; 60% or less; 50% or less; 40% or less; 30% or less; or 20% or less of the inside diameter of the pipeline 610 to be cleaned.

The fluid flush connection 730 may include one or more connections to accept the coupling of a flush fluid supply line. In some embodiments, the flush fluid may include a liquid flushing agent, such as water. In some embodiments, the flush fluid may include a gaseous flushing agent, such as air. In some embodiments, the flush fluid may include a combination of liquid and gaseous flushing agents. The fluid flush connection 730 may include one or more female threaded connections, one or more male threaded connections, one or more female quick-connect connections, one or more male quick connect connections, or combinations thereof. The size of the fluid flush connection 730 may be based, at least in part on the diameter of the stabilizer element 710. For example, larger diameter stabilizer elements 710 may have one or more relatively larger fluid flush connections 730 than a smaller diameter stabilizer element 710. The fluid flush connection 730 may have a diameter of about: 0.25 inches (in) or greater; 0.375 in or greater; 0.50 in or greater; 0.625 in or greater; 0.75 in or greater; 0.875 in or greater; 1.00 in or greater; 1.25 in or greater; 1.5 in or greater; or 2.00 in or greater.

The one or more fluid conduits 740A-740n fluidly couple the fluid flush connection 730 to the space between the stabilizer element 710 and the rotatable cleaning head assembly 110. Although depicted as including three fluid conduits in FIGS. 7A-7E, any number of fluid conduits may be formed in the stabilizer element 710. Each of the one or more fluid conduits 740 may have the same or different physical geometry (e.g., circular, oval, polygonal) and/or the same or different diameter. For example, each of the one or more fluid conduits 740A-740n may have a diameter of about: 0.125 inches (in) or less; 0.25 in or less; 0.375 in or less; 0.50 in or less; 0.625 in or less; 0.75 in or less; 0.875 in or less; or 1 in or less.

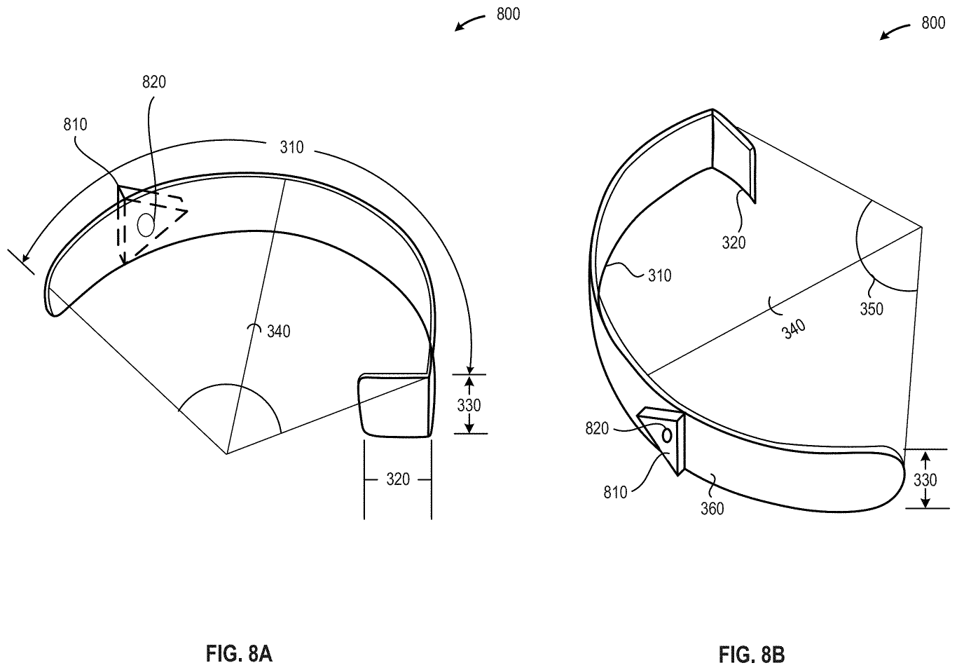

FIG. 8A is a rear perspective view of an illustrative flexible metal element 800 that includes at least one tooth 810 disposed in, on, or about at least a portion of the external surface of the arcuate flexible metal element 800, in accordance with at least one embodiment described herein. FIG. 3B is another perspective view of the illustrative arcuate flexible metal element 800 depicted in FIG. 3A, in accordance with at least one embodiment described herein.

Each of the arcuate flexible metal elements 800 include an arcuate portion 310 and a lock portion 320. At least a portion of the arcuate portion 310 extends from the cylindrical body 112 and the lock portion 320 retains the arcuate portion within the cylindrical body 112. The arcuate portion 310 has a radius 340 and an arc length. The lock portion 320 may include a straight section that extends a distance 322 from the arcuate portion 310. Although the lock portion 320 is depicted in FIGS. 8A and 8B as a straight section, other physical geometries (curved, arcuate, coiled etc.) may be used to form all or a portion of the lock portion 320. The arcuate flexible metal element 800 may be fabricated using one or more metals having a thickness sufficient to permit the arcuate flexible metal elements 800A-800n that form a arcuate flexible metal element ring 122 to overlap such that a ring 122 having a continuous perimeter is formed by overlapping at least a portion of each arcuate flexible metal element 800 over at least one neighboring arcuate flexible metal element 800. Each of some or all of the arcuate flexible metal elements 800 includes a tooth 810 disposed in, on, or about at least a portion of the external surface of the arcuate flexible metal element 800. In operation, the at least one tooth 810 contacts the interior wall of the pipeline to be cleaned. Beneficially, the at least one tooth 810 assists in removing built-up deposits or accretions on the interior wall of the pipeline.

The radius 340 of the arcuate portion 310 of each arcuate flexible metal element 800 may be based, at least in part, on the diameter 118 of the cylindrical body 112. The arc length of the arcuate portion 310 of each arcuate flexible metal elements 800 may be based, at least in part, on the diameter 118 of the cylindrical body 112. In embodiments, the arc length of the arcuate portion 310 of each of the arcuate flexible metal elements 800 may be determined by the angle 350 subtended by the arcuate portion 310. The angle 350 subtended by the arcuate portion 310 of each of the arcuate flexible metal elements 800 may range: from about 20° to about 180°; from about 40° to about 160°; from about 45° to about 135°; from about 60° to about 120°; from about 75° to about 110°; or from about 80° to about 105°. In embodiments, the terminus of the arcuate portion 310 of each of some or all of the plurality of arcuate flexible metal elements 120 may be radiused as depicted in FIGS. 8A and 8B. In other embodiments, the terminus of the arcuate portion 310 of each of some or all of the plurality of arcuate flexible metal elements 800 may have any physical geometry, such as square, triangular, multi-pronged, and similar.

Each of the arcuate flexible metal elements 800A-800n may be formed using a metal demonstrating spring-like properties such as spring steel or spring stainless steel. As depicted in FIGS. 8A and 8B, in at least some embodiments, the at least one tooth 810 may be fastened, affixed, or otherwise bonded to at least a portion of the external surface of the arcuate flexible metal element 800. The at least one tooth 810 may be physically affixed to the arcuate flexible metal element 800 using one or more fixture devices such as screws, rivets, or similar. In embodiments, the at least one tooth 810 may be detachably attached to the arcuate flexible metal element 800. In other embodiments, the at least one tooth 810 may be permanently affixed to the arcuate flexible metal element 800. The at least one tooth 810 may be fabricated using one or more materials such as tungsten carbide or similar. The at least one tooth 810 may be at least partially covered or coated with an abrasive coating, such as aluminum oxide or diamond.

Although the at least one tooth 810 depicted in FIGS. 8A and 8B demonstrate a triangular physical geometry, other physical geometries may be substituted with equal efficiency. In embodiments, the at least one tooth 810 disposed on the exterior surface of the arcuate flexible metal element 800 may extend a distance of about: 0.1 inches (in) or less; 0.2 in or less; 0.3 in or less; 0.4 in or less; 0.5 in or less from the external surface of the respective arcuate flexible metal element 800. In embodiments, the at least one tooth 810 may have the same width as the width 330 of the arcuate flexible metal element 800 on which the respective tooth 810 is disposed. In embodiments, the at least one tooth 810 may have a different width that may be greater than or less than the width 330 of the arcuate flexible metal element 800 on which the respective tooth 810 is disposed.

Each of arcuate flexible metal element 800 may have the same or a different width 330. For example, each of the arcuate flexible metal elements 800 may have a width of about: 0.25 inches (in.) or less; 0.375 in. or less; 0.50 in. or less; 0.625 in. or less; 0.75 in. or less; 0.875 in. or less; 1.00 in. or less; 1.25 in. or less; 1.50 in. or less; 1.75 in. or less; or 2.00 in. or less. Each of the arcuate flexible metal elements 800 may have the same or a different thickness. For example, each of the arcuate flexible metal elements 8000 may have a thickness of about: 10 gauge ( 9/64″) or thinner; 16 gauge ( 1/16″) or thinner, 20 gauge ( 3/80″) or thinner; or 28 gauge ( 1/64″) or thinner.

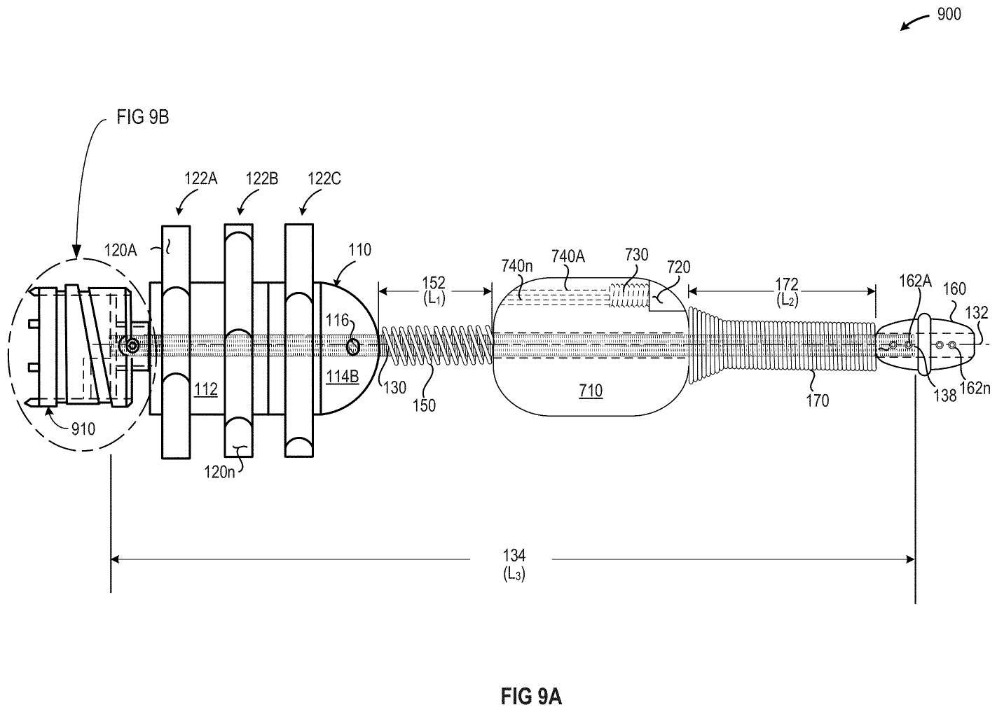

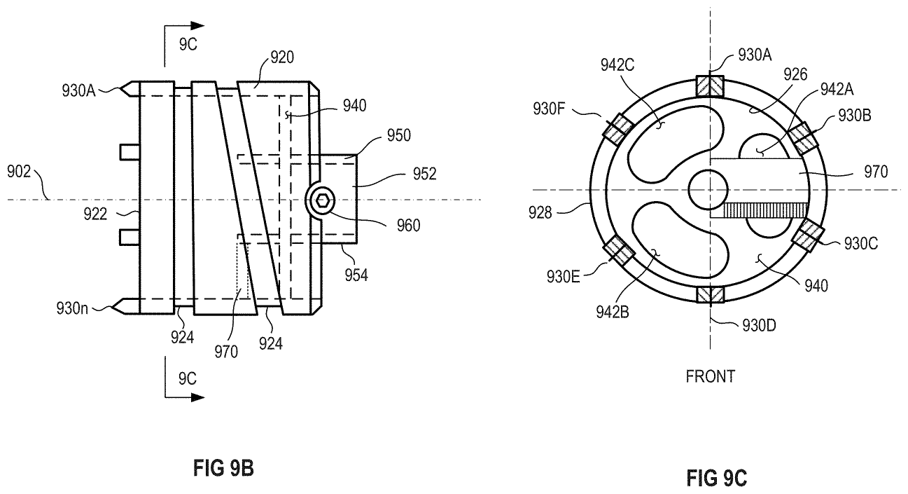

FIG. 9A is a side elevation of an illustrative pipeline cleanout tool 900 having a rotatable cleaning head assembly 110 that includes a cutting head assembly 910 physically coupled to the first end 134 of the flexible rotatable shaft 130 instead of the first end cap 114A, in accordance with at least one embodiment described herein. FIG. 9B is an enlarged side elevation of the cutting head assembly 910 included on the rotatable cleaning head assembly 110 depicted in FIG. 9A, in accordance with at least one embodiment described herein. FIG. 9C is a transverse cross-sectional elevation of the illustrative cutting head 910 depicted in FIG. 9B along sectional line 9C-9C, in accordance with at least one embodiment described herein. In at least some embodiments, the first end cap 114A included in the rotatable cleaning head assembly 110 may be replaced by a cutting head assembly 910. Replacing the first end cap 114A with the cutting head assembly 910 beneficially and advantageously improves the ability of the rotatable cleaning head assembly 110 to remove even hardened deposits and/or accretions on the inside surfaces of a pipeline.

The hollow cylindrical member 920 includes an internal surface 926 and an external surface 928. In embodiments, one or more detents, recesses, and/or grooves 924 may be disposed, cut, pressed, or otherwise formed in, on, about, or across at least a portion of the external surface 928 of the hollow cylindrical member 920. In embodiments, the one or more grooves 924 may include one or more helical or spiral grooves formed in the external surface 928 of the hollow cylindrical member 920. The hollow cylindrical member 920 may have any outside diameter, material thickness, and/or inside diameter. For example, the hollow cylindrical member 920 may have an outside diameter that is similar to the outside diameter 118 of the cylindrical body 112. In embodiments, the hollow cylindrical member 920 may have a diameter of about: 1 inch (in) or less; 1.5 in or less; 2 in or less; 2.5 in or less; 3 in or less; 4 in or less; 6 in or less; or 10 in or less. In embodiments, the hollow cylindrical member 920 may have a wall thickness of about: 0.125 inches (in) or less; 0.25 in or less; 0.375 in or less; 0.5 in or less; or 0.625 in or less.

A plurality of teeth 930A-930n (collectively, “teeth 930”) extend longitudinally (i.e., generally parallel to the longitudinal axis 132 of the flexible rotatable shaft 130) from a first end 922 of the hollow cylindrical member 920. Each of the teeth 930A-930n may be oriented such that the abrasive or cutting portion of each of the teeth 930 extend outward from the longitudinal axis 132 of the flexible rotatable shaft 130. The teeth 930 may be physically coupled to the hollow cylindrical member 920 or formed integral with the hollow cylindrical member 920. Although for clarity only six (6) teeth 930A-930F are depicted in FIGS. 9A-9C, any number of teeth 930 may be evenly or unevenly spaced about the first end 922 of the hollow cylindrical member 920. In embodiments, the lateral surface of some or all of the teeth 930 may extend radially outward, past the external surface 928 of the hollow cylindrical member 920. In other embodiments, the lateral surface of some or all of the teeth 930 may be flush with the external surface 928 of the hollow cylindrical member 920. In embodiments, the teeth 930 may extend the same or different distances from the first end 922 of the hollow cylindrical member 920. In embodiments, the teeth 930 may be fabricated using any type or combination of materials. For example, in some embodiments, the teeth 930 may include teeth fabricated using a carbide-containing compound such as tungsten carbide. In embodiments, some or all of the teeth 930 may include one or more abrasive coatings, such as diamond and/or aluminum oxide. Although 6 teeth are depicted on the illustrative cutting head assembly 910 in FIGS. 9A-9C, any number of teeth 930A-930n may be disposed evenly or unevenly about the first end 922 of the hollow cylindrical member 920.

In embodiments, an attachment member 940 is disposed within the hollow cylindrical member 920. In at least some embodiments, the attachment member 940 may be disposed at least partially within the hollow cylindrical member 920 and transverse to the longitudinal axis 902 of the cutting head assembly 910. In at least some embodiments, the attachment member 940 may include a disc shaped member having a central aperture 952 sufficient in diameter to pass the flexible rotatable shaft 130. In some embodiments, the attachment member 940 may include a single bar or rectangular shaped member disposed transverse to the longitudinal axis 902 of the cutting head assembly 910. In other embodiments, the attachment member 940 may include an “X” or cross shaped member disposed transverse to the longitudinal axis 902 of the cutting head assembly 910. The attachment member 940 may be formed integral with the hollow cylindrical member 920. The attachment member 940 may be formed separate from the hollow cylindrical member 920 and affixed to the internal surface 926 of the hollow cylindrical member 920, for example by welding, thermal bonding, chemical bonding, or compression fitting. The attachment member 940 may be detachably attached to the hollow cylindrical member 920, for example using threaded fasteners, snap rings, or similar attachment devices.

An attachment sleeve 950 may be detachably attached or permanently affixed to the attachment member 940 proximate the aperture formed in the attachment member 940. In embodiments, the attachment sleeve 950 may include a hollow cylindrical member having a central aperture 952 of sufficient diameter to permit the passage of the flexible rotatable shaft 130 therethrough. A plurality of shaft fasteners 960 may be disposed in equally or unequally spaced locations radially about the attachment sleeve 950. The shaft fasteners 960 detachably attach the cutting head assembly 910 to the flexible rotatable shaft 130. In at least some embodiments, the shaft fasteners 960 may include set screws or similar threaded fasteners disposed radially about the attachment sleeve 950 at equal angles (e.g., 3 shaft fasteners 960 spaced at 120°) or unequal angles (e.g., 3 shaft fasteners 960, the first two positioned at 90° with respect to each other, the third positioned at 135° with respect to each of the first two).

As depicted in FIGS. 9A-9C, in embodiments, the cutting head assembly 910 may include a blade 970 disposed at least partially within the hollow cylindrical member 920 and extending radially outward from the longitudinal axis 902 of the cutting head assembly 910. The cutting head assembly 910 includes an attachment member 940 having a plurality of apertures 942A-942C (collectively, “apertures 942”) formed therethrough. Although three apertures 942A-942C are depicted in FIG. 9C, any number of apertures may be provided with equal efficiency. The apertures 942 beneficially permit the passage of debris, detritus, and other materials through the cutting head assembly 910 as contact is maintained between the cutting head assembly 910 and the accumulated debris and/or accretions deposited in the pipeline 610 to be cleaned.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

According to example 1, there is provided a pipeline cleanout tool. The pipeline cleanout tool may include: a flexible shaft having a longitudinal axis, a first end, and a second end; a rotatable cleaning head disposed proximate the first end of the shaft, the rotatable cleaning head including: a first end cap having an aperture formed centrally through a thickness of the first end cap, the aperture to accommodate the passage of the flexible shaft; a second end cap an aperture formed centrally through a thickness of the second end cap, the aperture to accommodate the passage of the flexible shaft; and at least one cylindrical body disposed between the first end cap and the second end cap, the at least one cylindrical body including: an aperture formed centrally through a thickness of the at least one cylindrical body, the aperture to accommodate the passage of the flexible shaft; a first surface having a first plurality of grooves formed therein, each of the first plurality of grooves to accept the insertion of at least one arcuate flexible metal element, each arcuate flexible metal element extending spirally outward from an external surface of the at least one cylindrical body; and a second surface transversely opposed across the thickness of the at least one cylindrical body from the first surface, the second surface having a second plurality of grooves formed therein, each of the second plurality of grooves to accept the insertion of the at least one arcuate flexible metal element, each of the arcuate flexible metal elements extending spirally outward from an external surface of the at least one cylindrical member; at least one spacer element disposed about the flexible shaft; and a compressible element disposed about the flexible shaft and positioned between the rotatable cleaning head and the at least one spacer element, the compressible element compressible along the longitudinal axis of the flexible shaft.

Example 2 may include elements of example 1 and the tool may further include: a coupling element disposed about the flexible shaft, proximate the second end of the flexible shaft.

Example 3 may include elements of any of examples 1 or 2 and the tool may further include: a flexible sleeve disposed about the flexible shaft and positioned between the coupling element and the spacer element.

Example 4 may include elements of any of examples 1 through 3 where the at least one cylindrical body comprises at least one cylindrical body having a first radius.

Example 5 may include elements of any of examples 1 through 4 where each of the plurality of grooves formed in the first surface of the at least one cylindrical body comprise a plurality grooves evenly spaced through a 360 degree arc, each of the plurality of grooves including a lock portion and a holder portion.

Example 6 may include elements of any of examples 1 through 5 where each of the plurality of grooves formed in the second surface of the at least one cylindrical body comprise a plurality grooves evenly spaced through a 360 degree arc, each of the plurality of grooves including a lock portion and a holder portion.

Example 7 may include elements of any of examples 1 through 6 where each arcuate flexible metal element may include: a spring metal strip having a first end and a second end, the spring metal strip forming an arc having an inside surface and an outside surface, the spring metal strip having a radius of curvature that is greater than the first radius of the cylindrical body and including a lock portion to retain the arcuate flexible metal element in the cylindrical body and an arcuate portion that extends from the cylindrical body.

Example 8 may include elements of any of examples 1 through 7 where each of the at least one arcuate flexible metal element may further include: an abrasive material deposited on at least a portion of the outside surface of the at least one arcuate flexible metal element.

Example 9 may include elements of any of examples 1 through 8 where the first end cap includes a plurality of fastening elements to physically couple the first end cap to the flexible shaft; and where the second end cap includes a plurality of fastening elements to physically couple the first end cap to the flexible shaft.

Example 10 may include elements of any of examples 1 through 9 where the first end cap comprises a member having at least one planar surface disposed proximate the at least one cylindrical body; and where the second end cap comprises a member having at least one planar surface disposed proximate the at least one cylindrical body.

Example 11 may include elements of any of examples 1 through 10 where the first surface of the at least one cylindrical body includes a plurality of sockets and wherein the first end cap includes a corresponding plurality of sockets, each to receive a pin to limit rotational differences between the at least one cylindrical body and the first end cap; and where the second surface of the at least one cylindrical body includes a plurality of sockets and wherein the second end cap includes a corresponding plurality of sockets, each to receive a pin to limit rotational differences between the at least one cylindrical body and the second end cap.

Example 12 may include elements of any of examples 1 through 11 where the first end cap includes a plurality of threaded apertures and the first surface of the cylindrical body includes a corresponding plurality of threaded apertures, each of the plurality of threaded apertures to accept the insertion of a threaded fastener to physically couple the first end cap to the at least one cylindrical body; and where the second end cap includes a plurality of threaded apertures and the second surface of the cylindrical body includes a corresponding plurality of threaded apertures, each of the plurality of threaded apertures to accept the insertion of a threaded fastener to physically couple the second end cap to the at least one cylindrical body.

Example 13 may include elements of any of examples 1 through 12 where the first end cap comprises a hemispherical member having at least one planar surface disposed proximate the at least one cylindrical body; and where the second end cap comprises a hemispherical member having at least one planar surface disposed proximate the at least one cylindrical body.

Example 14 may include elements of any of examples 1 through 13 where the compressible element comprises a helical spring disposed about the flexible shaft.

According to example 15, there is provided a pipeline cleanout tool. The tool may include: a flexible shaft having a longitudinal axis, a first end, and a second end; a rotatable cleaning head disposed about the flexible shaft and proximate the first end of the flexible shaft, the rotatable cleaning head including a body having a first radius and including: a plurality of arcuate flexible metal elements extending spirally outward from the body, each of the plurality of arcuate flexible metal elements having a radius of curvature greater than the first radius; at least one spacer element disposed about the flexible shaft between the rotatable cleaning head and the second end of the flexible shaft; and a compressible element disposed about the flexible shaft and positioned between the rotatable cleaning head and the at least one spacer element, the compressible element compressible along the longitudinal axis of the flexible shaft.

Example 16 may include elements of example 15 where the body comprises a multi-piece body that includes: a first end cap disposed about the flexible shaft, the first end cap including an aperture formed centrally through a thickness of the first end cap, the aperture to accommodate the passage of the flexible shaft; a second end cap disposed about the flexible shaft, the second end cap including an aperture formed centrally through a thickness of the second end cap, the aperture to accommodate the passage of the flexible shaft; and a cylindrical body disposed about the flexible shaft, the cylindrical body having an aperture formed centrally therethrough, the cylindrical body disposed between the first end cap and the second end cap, the cylindrical body including a plurality of grooves, each of the plurality of grooves to retain a respective one of the plurality of arcuate flexible metal elements.

Example 17 may include elements of any of examples 15 or 16 and the tool may further include: a coupling element disposed about the flexible shaft, proximate the second end of the flexible shaft.

Example 18 may include elements of any of examples 15 through 17 and the tool may additionally include: a flexible sleeve disposed about the flexible shaft and positioned between the coupling element and the spacer element.

Example 19 may include elements of any of examples 15 through 18 where the cylindrical body includes a first surface and a second surface transversely opposed across the thickness of the cylindrical body from the first surface; where the cylindrical body includes a plurality of grooves formed in the first surface, each of the plurality grooves evenly spaced through a 360° arc and including a locking portion to retain the arcuate flexible metal element in the cylindrical body and an arcuate portion, at least a portion of which extends spirally from the cylindrical body; and where the cylindrical body includes a plurality of grooves formed in the second surface, each of the plurality grooves evenly spaced through a 360° arc and including a locking portion to retain the arcuate flexible metal element in the cylindrical body and an arcuate portion, at least a portion of which extends spirally from the cylindrical body.

Example 20 may include elements of any of examples 15 through 19 where each of the at least one arcuate flexible metal element may include: an abrasive material deposited on at least a portion of a surface of each of the arcuate flexible metal element.

Example 21 may include elements of any of examples 15 through 20 where the first end cap includes a plurality of fastening elements to physically couple the first end cap to the flexible shaft; and where the second end cap includes a plurality of fastening elements to physically couple the first end cap to the flexible shaft.

Example 22 may include elements of any of examples 15 through 21 where the first end cap comprises a member having at least one planar surface disposed proximate the cylindrical body; and where the second end cap comprises a member having at least one planar surface disposed proximate the cylindrical body.

Example 23 may include elements of any of examples 15 through 22 where the first surface of the cylindrical body includes a plurality of sockets and wherein the first end cap includes a corresponding plurality of sockets, each to receive a pin to limit rotational differences between the cylindrical body and the first end cap; and where the second surface of the cylindrical member includes a plurality of sockets and wherein the second end cap includes a corresponding plurality of sockets, each to receive a pin to limit rotational differences between the cylindrical body and the second end cap.

Example 24 may include elements of any of examples 15 through 23 where the first end cap includes a plurality of threaded apertures and the first surface of the cylindrical body includes a corresponding plurality of threaded apertures, each of the plurality of threaded apertures to accept the insertion of a threaded fastener to physically couple the first end cap to the cylindrical body; and where the second end cap includes a plurality of threaded apertures and the second surface of the cylindrical body includes a corresponding plurality of threaded apertures, each of the plurality of threaded apertures to accept the insertion of a threaded fastener to physically couple the second end cap to the cylindrical body.

Example 25 may include elements of any of examples 15 through 24 where the first end cap comprises a hemispherical member having at least one planar surface disposed proximate the cylindrical member; and where the second end cap comprises a hemispherical member having at least one planar surface disposed proximate the cylindrical member.

Example 26 may include elements of any of examples 15 through 25 where the compressible element comprises a helical spring disposed about the flexible shaft.

According to example 27, there is provided a pipeline cleanout head that includes: a plurality of arcuate flexible metal elements; a cylindrical body having a first radius, a first surface and a second surface transversely opposed across a thickness of the cylindrical body from the first surface, the cylindrical body further including: an aperture formed centrally through a thickness of the cylindrical body, the aperture to accommodate passage of a flexible shaft; a first plurality of grooves formed in the first surface, each of the first plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body; and a second plurality of grooves formed in the second surface, each of the second plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body.

Example 28 may include elements of example 27 where each of the grooves included in the first plurality of grooves is offset from each of the grooves included in the second plurality of grooves.

Example 29 may include elements of any of examples 27 or 28 where the plurality of grooves includes at least 6 grooves and the second plurality of grooves includes an equal number of grooves to the first plurality of grooves.

Example 30 may include elements of any of examples 27 through 29 where each of the plurality of arcuate flexible metal elements includes a spring metal strip having a radius of curvature greater than 1.1 times the first radius of the cylindrical body and extending spirally outward from an external surface of the at least one cylindrical member.

Example 31 may include elements of any of examples 27 through 30 where each of the plurality of arcuate flexible metal elements includes a spring metal strip having a thickness of less than about 0.5 millimeters (mm).

Example 32 may include elements of any of examples 27 through 31 where each of the plurality of arcuate flexible metal elements may further include: an abrasive material deposited on at least a portion of the outside surface of the arcuate flexible metal element.

Example 33 may include elements of any of examples 27 through 32, and the cleanout head may additionally include: a first end cap, at least a portion of the first end cap having a planar first surface disposed proximate the first surface of the cylindrical body; and a second end cap, at least a portion of the second end cap having a planar second surface disposed proximate the second surface of the cylindrical body.

Example 34 may include elements of any of examples 27 through 33 where the first surface of the cylindrical body includes a plurality of cavities and wherein the first end cap includes a corresponding plurality of cavities to receive a member to limit rotational differences between the cylindrical body and the first end cap; and where the second surface of the cylindrical body includes a plurality of cavities and wherein the second end cap includes a corresponding plurality of cavities to receive a member to limit rotational differences between the cylindrical body and the second end cap.

Example 35 may include elements of any of examples 27 through 34 where the first end cap includes a plurality of threaded apertures and the first surface of the cylindrical body includes a corresponding plurality of threaded apertures, each of the plurality of threaded apertures to accept the insertion of a threaded fastener to physically couple the first end cap to the cylindrical body; and where the second end cap includes a plurality of threaded apertures and the second surface of the cylindrical body includes a corresponding plurality of threaded apertures, each of the plurality of threaded apertures to accept the insertion of a threaded fastener to physically couple the second end cap to the cylindrical body.

Example 36 may include elements of any of examples 27 through 35 where the first end cap comprises a hemispherical member that includes the planar first surface; and where the second end cap comprises a hemispherical member that includes the planar second surface.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

What is claimed:

1. A pipeline cleanout tool, comprising:
a flexible shaft having a longitudinal axis, a first end, and a second end;
a rotatable cleaning head disposed about the flexible shaft and proximate the first end of the flexible shaft, the rotatable cleaning head including a body having a first radius and including:
a plurality of arcuate flexible metal elements extending spirally outward from the body, each of the plurality of arcuate flexible metal elements having a radius of curvature greater than the first radius;
at least one spacer element disposed about the flexible shaft between the rotatable cleaning head and the second end of the flexible shaft; and
a compressible element disposed about the flexible shaft and positioned between the rotatable cleaning head and the at least one spacer element, the compressible element compressible along the longitudinal axis of the flexible shaft.

2. The pipeline cleaning tool of claim 1 wherein the body comprises a multi-piece body that includes:
a first end cap disposed about the flexible shaft, the first end cap including an aperture formed centrally through a thickness of the first end cap, the aperture to accommodate the passage of the flexible shaft;
a second end cap disposed about the flexible shaft, the second end cap including an aperture formed centrally through a thickness of the second end cap, the aperture to accommodate the passage of the flexible shaft; and
a cylindrical body disposed about the flexible shaft, the cylindrical body having an aperture formed centrally therethrough, the cylindrical body disposed between the first end cap and the second end cap, the cylindrical body including a plurality of grooves, each of the plurality of grooves to retain a respective one of the plurality of arcuate flexible metal elements.

3. The pipeline cleanout tool of claim 1 further comprising:
a coupling element disposed about the flexible shaft, proximate the second end of the flexible shaft.

4. The pipeline cleanout tool of claim 3 further comprising:
a flexible sleeve disposed about the flexible shaft and positioned between the coupling element and the spacer element.

5. The pipeline cleanout tool of claim 1:
wherein the cylindrical body includes a first surface and a second surface transversely opposed across the thickness of the cylindrical body from the first surface;
wherein the cylindrical body includes a plurality of grooves formed in the first surface, each of the plurality grooves evenly spaced through a 360° arc and including a locking portion to retain the arcuate flexible metal element in the cylindrical body and an arcuate portion, at least a portion of which extends spirally from the cylindrical body; and
wherein the cylindrical body includes a plurality of grooves formed in the second surface, each of the plurality grooves evenly spaced through a 360° arc and including a locking portion to retain the arcuate flexible metal element in the cylindrical body and an arcuate portion, at least a portion of which extends spirally from the cylindrical body.

6. The pipeline cleanout tool of claim 1 wherein each of the at least one arcuate flexible metal element further comprises:
an abrasive material deposited on at least a portion of a surface of each of the arcuate flexible metal element.

7. The pipeline cleanout tool of claim 2:
wherein the first end cap includes a plurality of fastening elements to physically couple the first end cap to the flexible shaft; and
wherein the second end cap includes a plurality of fastening elements to physically couple the first end cap to the flexible shaft.

8. The pipeline cleanout tool of claim 2:
wherein the first end cap comprises a member having at least one planar surface disposed proximate the cylindrical body; and
wherein the second end cap comprises a member having at least one planar surface disposed proximate the cylindrical body.

9. The pipeline cleanout tool of claim 8:
wherein the first surface of the cylindrical body includes a plurality of sockets and wherein the first end cap includes a corresponding plurality of sockets, each to receive a pin to limit rotational differences between the cylindrical body and the first end cap; and
wherein the second surface of the cylindrical member includes a plurality of sockets and wherein the second end cap includes a corresponding plurality of sockets, each to receive a pin to limit rotational differences between the cylindrical body and the second end cap.

10. The pipeline cleanout tool of claim 9:
wherein the first end cap includes a plurality of threaded apertures and the first surface of the cylindrical body includes a corresponding plurality of threaded apertures, each of the plurality of threaded apertures to accept the insertion of a threaded fastener to physically couple the first end cap to the cylindrical body; and
wherein the second end cap includes a plurality of threaded apertures and the second surface of the cylindrical body includes a corresponding plurality of threaded apertures, each of the plurality of threaded apertures to accept the insertion of a threaded fastener to physically couple the second end cap to the cylindrical body.

11. The pipeline cleanout tool of claim 2:
wherein the first end cap comprises a hemispherical member having at least one planar surface disposed proximate the cylindrical member; and
wherein the second end cap comprises a hemispherical member having at least one planar surface disposed proximate the cylindrical member.

12. The pipeline cleanout tool of claim 1 wherein the compressible element comprises a helical spring disposed about the flexible shaft.

13. A pipeline cleanout head, comprising:
a plurality of arcuate flexible metal elements;
a cylindrical body having a first radius, a first surface and a second surface transversely opposed across a thickness of the cylindrical body from the first surface, the cylindrical body further including:
an aperture formed centrally through a thickness of the cylindrical body, the aperture to accommodate passage of a flexible shaft;
a first plurality of grooves formed in the first surface, each of the first plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body; and
a second plurality of grooves formed in the second surface, each of the second plurality of grooves to accept the insertion of at least a portion of at least one of the plurality of arcuate flexible metal elements; each arcuate flexible metal element having a radius of curvature greater than 1.1 times the first radius of the cylindrical body and extending spirally outward from an external surface of the cylindrical body.

14. The pipeline cleanout head of claim 13:
wherein each of the grooves included in the first plurality of grooves is offset from each of the grooves included in the second plurality of grooves.

15. The pipeline cleanout head of claim 13:
wherein the plurality of grooves includes at least 6 grooves and the second plurality of grooves includes an equal number of grooves to the first plurality of grooves.

16. The pipeline cleanout head of claim 13:
wherein each of the plurality of arcuate flexible metal elements includes a spring metal strip having a radius of curvature greater than 1.1 times the first radius of the cylindrical body and extending spirally outward from an external surface of the at least one cylindrical member.

17. The pipeline cleanout head of claim 16:
wherein each of the plurality of arcuate flexible metal elements includes a spring metal strip having a thickness of less than about 0.5 millimeters (mm).

18. The pipeline cleanout head of claim 13 wherein each of the plurality of arcuate flexible metal elements further comprises:
an abrasive material deposited on at least a portion of the outside surface of the arcuate flexible metal element.

19. The pipeline cleanout head of claim 13, further comprising:
a first end cap, at least a portion of the first end cap having a planar first surface disposed proximate the first surface of the cylindrical body; and
a second end cap, at least a portion of the second end cap having a planar second surface disposed proximate the second surface of the cylindrical body.

20. The pipeline cleanout head of claim 19:
wherein the first surface of the cylindrical body includes a plurality of cavities and wherein the first end cap includes a corresponding plurality of cavities to receive a member to limit rotational differences between the cylindrical body and the first end cap; and
wherein the second surface of the cylindrical body includes a plurality of cavities and wherein the second end cap includes a corresponding plurality of cavities to receive a member to limit rotational differences between the cylindrical body and the second end cap.

21. The pipeline cleanout head of claim 19:
wherein the first end cap includes a plurality of threaded apertures and the first surface of the cylindrical body includes a corresponding plurality of threaded apertures, each of the plurality of threaded apertures to accept the insertion of a threaded fastener to physically couple the first end cap to the cylindrical body; and
wherein the second end cap includes a plurality of threaded apertures and the second surface of the cylindrical body includes a corresponding plurality of threaded apertures, each of the plurality of threaded apertures to accept the insertion of a threaded fastener to physically couple the second end cap to the cylindrical body.

22. The pipeline cleanout head of claim 19:
wherein the first end cap comprises a hemispherical member that includes the planar first surface; and
wherein the second end cap comprises a hemispherical member that includes the planar second surface.

23. A pipeline cleanout tool, comprising:
a flexible shaft having a longitudinal axis, a first end, and a second end;
a rotatable cleaning head disposed proximate the first end of the shaft, the rotatable cleaning head including:
a first end cap having an aperture formed centrally through a thickness of the first end cap, the aperture to accommodate the passage of the flexible shaft;
a second end cap an aperture formed centrally through a thickness of the second end cap, the aperture to accommodate the passage of the flexible shaft; and
at least one cylindrical body disposed between the first end cap and the second end cap, the at least one cylindrical body including:
an aperture formed centrally through a thickness of the at least one cylindrical body, the aperture to accommodate the passage of the flexible shaft;
a first surface having a first plurality of grooves formed therein, each of the first plurality of grooves to accept the insertion of at least one arcuate flexible metal element, each arcuate flexible metal element extending spirally outward from an external surface of the at least one cylindrical body; and
a second surface transversely opposed across the thickness of the at least one cylindrical body from the first surface, the second surface having a second plurality of grooves formed therein, each of the second plurality of grooves to accept the insertion of the at least one arcuate flexible metal element, each of the arcuate flexible metal elements extending spirally outward from an external surface of the at least one cylindrical member;
at least one spacer element disposed about the flexible shaft; and
a compressible element disposed about the flexible shaft and positioned between the rotatable cleaning head and the at least one spacer element, the compressible element compressible along the longitudinal axis of the flexible shaft.

24. The pipeline cleanout tool of claim 23 wherein the at least one cylindrical body comprises at least one cylindrical body having a first radius.

25. The pipeline cleanout tool of claim 24:
wherein each of the plurality of grooves formed in the first surface of the at least one cylindrical body comprise a plurality grooves evenly spaced through a 360 degree arc, each of the plurality of grooves including a lock portion and a holder portion; and
wherein each of the plurality of grooves formed in the second surface of the at least one cylindrical body comprise a plurality grooves evenly spaced through a 360 degree arc, each of the plurality of grooves including a lock portion and a holder portion.

26. The pipeline cleanout tool of claim 25 wherein each arcuate flexible metal element comprises:
a spring metal strip having a first end and a second end, the spring metal strip forming an arc having an inside surface and an outside surface, the spring metal strip having a radius of curvature that is greater than the first radius of the cylindrical body and including a lock portion to retain the arcuate flexible metal element in the cylindrical body and an arcuate portion that extends from the cylindrical body.

27. The pipeline cleanout tool of claim 23:
wherein the first end cap includes a plurality of fastening elements to physically couple the first end cap to the flexible shaft; and
wherein the second end cap includes a plurality of fastening elements to physically couple the first end cap to the flexible shaft.

28. The pipeline cleanout tool of claim 23:
wherein the first end cap comprises a member having at least one planar surface disposed proximate the at least one cylindrical body; and
wherein the second end cap comprises a member having at least one planar surface disposed proximate the at least one cylindrical body.

29. The pipeline cleanout tool of claim 28:
wherein the first surface of the at least one cylindrical body includes a plurality of sockets and wherein the first end cap includes a corresponding plurality of sockets, each to receive a pin to limit rotational differences between the at least one cylindrical body and the first end cap; and
wherein the second surface of the at least one cylindrical body includes a plurality of sockets and wherein the second end cap includes a corresponding plurality of sockets, each to receive a pin to limit rotational differences between the at least one cylindrical body and the second end cap.

30. The pipeline cleanout tool of claim 29:
wherein the first end cap includes a plurality of threaded apertures and the first surface of the cylindrical body includes a corresponding plurality of threaded apertures, each of the plurality of threaded apertures to accept the insertion of a threaded fastener to physically couple the first end cap to the at least one cylindrical body; and
wherein the second end cap includes a plurality of threaded apertures and the second surface of the cylindrical body includes a corresponding plurality of threaded apertures, each of the plurality of threaded apertures to accept the insertion of a threaded fastener to physically couple the second end cap to the at least one cylindrical body.
